(19) United States
(12) Patent Application Publication
(10) Pub. No.: US 2026/0220926 A1
(43) Pub. Date: Jul. 30, 2026

(54) OBSTACLE PREDICTION EVALUATION OF A MACHINE LEARNING MODEL

(71) Applicant: Motional AD LLC, Boston, MA (US)

(72) Inventors: Henggang Cui, Allison Park, PA (US); Akshay Bhagat, Boston, MA (US); Tung Phan, Garden Grove, CA (US); You Lu, Los Angeles, CA (US); Nachiket Deo, Los Angeles, CA (US)

(21) Appl. No.: 19/574,791

(22) Filed: Mar. 23, 2026

Related U.S. Application Data
(63) Continuation of application No. PCT/US2024/049662, filed on Oct. 2, 2024.
(60) Provisional application No. 63/587,972, filed on Oct. 4, 2023.

(51) Int. Cl. G06V 10/776; G06T 7/20; G06V 10/764; G06V 10/766; G06V 20/58

(52) U.S. Cl. CPC G06V 10/776; G06T 7/20; G06V 10/764; G06V 10/766; G06V 20/58; G06T 2207/20081; G06T 2207/30241; G06T 2207/30261; G06V 2201/08

(57) ABSTRACT

Provided are methods for evaluating a machine learning model's obstacle prediction, which can include determining that the machine learning model accurately predicted an obstacle based on a determination that the at least one predicted agent trajectory intersects with the predicted ego path at an intersection point and an indication from the ground truth data that the agent arrives at the intersection point before the ego vehicle.

### RELATED APPLICATIONS

Any and all applications for which a foreign or domestic priority claim is identified in the Application Data Sheet as filed with the present application are incorporated by reference under 37 CFR 1.57 and made a part of this specification. This application is a continuation of PCT Patent Application No. PCT/US2024/049662, filed on Oct. 2, 2024, entitled OBSTACLE PREDICTION EVALUATION OF A MACHINE LEARNING MODEL, which claims the priority benefit of U.S. Provisional Patent Application 63/587,972, entitled OBSTACLE PREDICTION EVALUATION OF A MACHINE LEARNING MODEL, filed Oct. 4, 2023, each of which is incorporated herein by reference in its entirety.

### BACKGROUND

Machine learning models may be used to detect agents in an image.

### BRIEF DESCRIPTION OF THE FIGURES

FIG. 1 is an example environment in which a vehicle including one or more components of an autonomous system can be implemented;

FIG. 2 is a diagram of one or more systems of a vehicle including an autonomous system;

FIG. 3 is a diagram of components of one or more devices and/or one or more systems of FIGS. 1 and 2;

FIG. 4A is a diagram of certain components of an autonomous system;

FIG. 4B is a diagram of an implementation of a neural network;

FIGS. 4C and 4D are a diagram illustrating example operation of a CNN;

FIG. 5 is a block diagram illustrating an evaluation environment to evaluate a machine learning model's ability to predict an obstacle;

FIG. 6A is a data flow diagram illustrating example communications between various components of the environment to evaluate the ability of the machine learning model to accurately predict an obstacle; and

FIGS. 6B-6D are bird's eye views of example scenes showing an ego vehicle and an agent.

FIGS. 7A-7D are bird's eye views of example scenes showing an ego vehicle, an agent, and predicted and ground truth trajectories for the ego vehicle and the agent.

FIG. 7E is a table of outcomes of scenarios involving an ego vehicle and an agent.

FIG. 7F illustrates a graph of precision-recall values.

FIGS. 8A-8C illustrate precision-recall curves generated based on data from three machine learning models.

FIG. 9 Is a flow diagram illustrating an example routine for improving the accuracy of a machine learning model.

### DETAILED DESCRIPTION

In the following description numerous specific details are set forth in order to provide a thorough understanding of the present disclosure for the purposes of explanation. It will be apparent, however, that the embodiments described by the present disclosure can be practiced without these specific details. In some instances, well-known structures and devices are illustrated in block diagram form in order to avoid unnecessarily obscuring aspects of the present disclosure.

Specific arrangements or orderings of schematic elements, such as those representing systems, devices, modules, instruction blocks, data elements, and/or the like are illustrated in the drawings for ease of description. However, it will be understood by those skilled in the art that the specific ordering or arrangement of the schematic elements in the drawings is not meant to imply that a particular order or sequence of processing, or separation of processes, is required unless explicitly described as such. Further, the inclusion of a schematic element in a drawing is not meant to imply that such element is required in all embodiments or that the features represented by such element may not be included in or combined with other elements in some embodiments unless explicitly described as such.

Further, where connecting elements such as solid or dashed lines or arrows are used in the drawings to illustrate a connection, relationship, or association between or among two or more other schematic elements, the absence of any such connecting elements is not meant to imply that no connection, relationship, or association can exist. In other words, some connections, relationships, or associations between elements are not illustrated in the drawings so as not to obscure the disclosure. In addition, for ease of illustration, a single connecting element can be used to represent multiple connections, relationships or associations between elements. For example, where a connecting element represents communication of signals, data, or instructions (e.g., “software instructions”), it should be understood by those skilled in the art that such element can represent one or multiple signal paths (e.g., a bus), as may be needed, to affect the communication.

Although the terms first, second, third, and/or the like are used to describe various elements, these elements should not be limited by these terms. The terms first, second, third, and/or the like are used only to distinguish one element from another. For example, a first contact could be termed a second contact and, similarly, a second contact could be termed a first contact without departing from the scope of the described embodiments. The first contact and the second contact are both contacts, but they are not the same contact.

The terminology used in the description of the various described embodiments herein is included for the purpose of describing particular embodiments only and is not intended to be limiting. As used in the description of the various described embodiments and the appended claims, the singular forms “a,” “an” and “the” are intended to include the plural forms as well and can be used interchangeably with “one or more” or “at least one,” unless the context clearly indicates otherwise. It will also be understood that the term “and/or” as used herein refers to and encompasses any and all possible combinations of one or more of the associated listed items. It will be further understood that the terms “includes,” “including,” “comprises,” and/or “comprising,” when used in this description specify the presence of stated features, integers, steps, operations, elements, and/or components, but do not preclude the presence or addition of one or more other features, integers, steps, operations, elements, components, and/or groups thereof.

As used herein, the terms “communication” and “communicate” refer to at least one of the reception, receipt, transmission, transfer, provision, and/or the like of information (or information represented by, for example, data, signals, messages, instructions, commands, and/or the like). For one unit (e.g., a device, a system, a component of a device or system, combinations thereof, and/or the like) to be in communication with another unit means that the one unit is able to directly or indirectly receive information from and/or send (e.g., transmit) information to the other unit. This may refer to a direct or indirect connection that is wired and/or wireless in nature. Additionally, two units may be in communication with each other even though the information transmitted may be modified, processed, relayed, and/or routed between the first and second unit. For example, a first unit may be in communication with a second unit even though the first unit passively receives information and does not actively transmit information to the second unit. As another example, a first unit may be in communication with a second unit if at least one intermediary unit (e.g., a third unit located between the first unit and the second unit) processes information received from the first unit and transmits the processed information to the second unit. In some embodiments, a message may refer to a network packet (e.g., a data packet and/or the like) that includes data.

As used herein, the term “if” is, optionally, construed to mean “when”, “upon”, “in response to determining,” “in response to detecting,” and/or the like, depending on the context. Similarly, the phrase “if it is determined” or “if [a stated condition or event] is detected” is, optionally, construed to mean “upon determining,” “in response to determining,” “upon detecting [the stated condition or event],” “in response to detecting [the stated condition or event],” and/or the like, depending on the context. Also, as used herein, the terms “has”, “have”, “having”, or the like are intended to be open-ended terms. Further, the phrase “based on” is intended to mean “based at least partially on” unless explicitly stated otherwise.

Reference will now be made in detail to embodiments, examples of which are illustrated in the accompanying drawings. In the following detailed description, numerous specific details are set forth in order to provide a thorough understanding of the various described embodiments. However, it will be apparent to one of ordinary skill in the art that the various described embodiments can be practiced without these specific details. In other instances, well-known methods, procedures, components, circuits, and networks have not been described in detail so as not to unnecessarily obscure aspects of the embodiments.

### General Overview

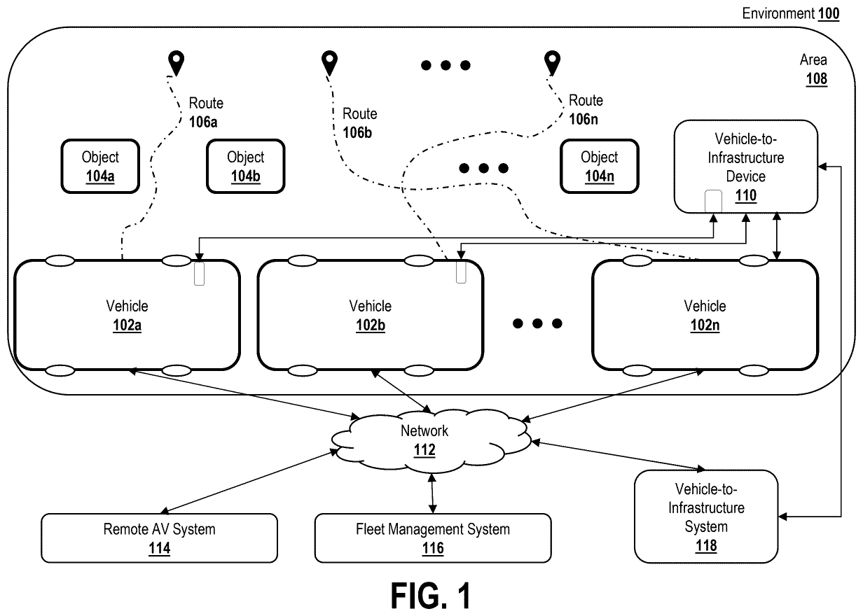

Referring now to FIG. 1, illustrated is example environment 100 in which vehicles that include autonomous systems, as well as vehicles that do not, are operated. As illustrated, environment 100 includes vehicles 102a-102n, objects 104a-104n, routes 106a-106n, area 108, vehicle-to-infrastructure (V2I) device 110, network 112, remote autonomous vehicle (AV) system 114, fleet management system 116, and V2I system 118. Vehicles 102a-102n, vehicle-to-infrastructure (V2I) device 110, network 112, autonomous vehicle (AV) system 114, fleet management system 116, and V2I system 118 interconnect (e.g., establish a connection to communicate and/or the like) via wired connections, wireless connections, or a combination of wired or wireless connections. In some embodiments, objects 104a-104n interconnect with at least one of vehicles 102a-102n, vehicle-to-infrastructure (V2I) device 110, network 112, autonomous vehicle (AV) system 114, fleet management system 116, and V2I system 118 via wired connections, wireless connections, or a combination of wired or wireless connections.

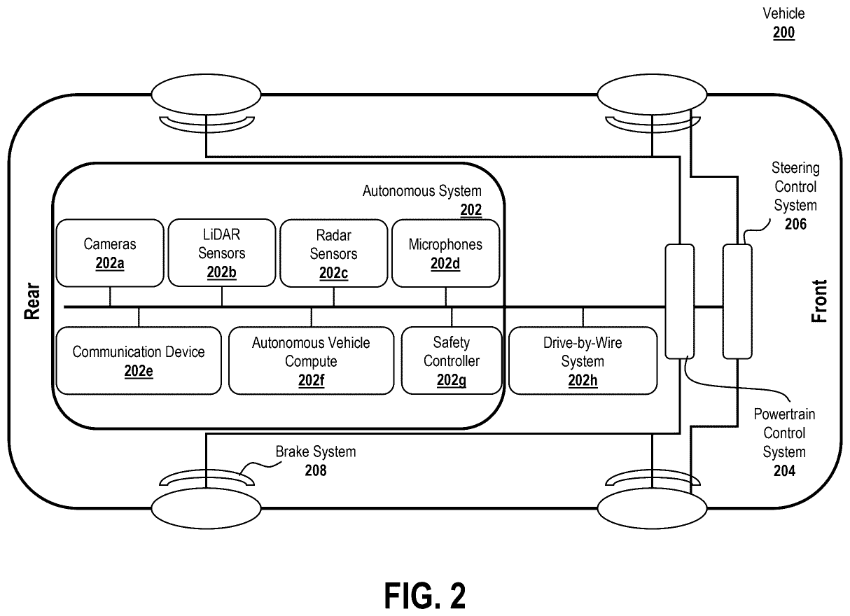

Vehicles 102a-102n (referred to individually as vehicle 102 and collectively as vehicles 102) include at least one device configured to transport goods and/or people. In some embodiments, vehicles 102 are configured to be in communication with V2I device 110, remote AV system 114, fleet management system 116, and/or V2I system 118 via network 112. In some embodiments, vehicles 102 include cars, buses, trucks, trains, and/or the like. In some embodiments, vehicles 102 are the same as, or similar to, vehicles 200, described herein (see FIG. 2). In some embodiments, a vehicle 200 of a set of vehicles 200 is associated with an autonomous fleet manager. In some embodiments, vehicles 102 travel along respective routes 106a-106n (referred to individually as route 106 and collectively as routes 106), as described herein. In some embodiments, one or more vehicles 102 include an autonomous system (e.g., an autonomous system that is the same as or similar to autonomous system 202).

Objects 104a-104n (referred to individually as object 104 and collectively as objects 104) include, for example, at least one vehicle, at least one pedestrian, at least one cyclist, at least one structure (e.g., a building, a sign, a fire hydrant, etc.), and/or the like. Each object 104 is stationary (e.g., located at a fixed location for a period of time) or mobile (e.g., having a velocity and associated with at least one trajectory). In some embodiments, objects 104 are associated with corresponding locations in area 108.

Routes 106a-106n (referred to individually as route 106 and collectively as routes 106) are each associated with (e.g., prescribe) a sequence of actions (also known as a trajectory) connecting states along which an AV can navigate. Each route 106 starts at an initial state (e.g., a state that corresponds to a first spatiotemporal location, velocity, and/or the like) and ends at a final goal state (e.g., a state that corresponds to a second spatiotemporal location that is different from the first spatiotemporal location) or goal region (e.g. a subspace of acceptable states (e.g., terminal states)). In some embodiments, the first state includes a location at which an individual or individuals are to be picked-up by the AV and the second state or region includes a location or locations at which the individual or individuals picked-up by the AV are to be dropped-off. In some embodiments, routes 106 include a plurality of acceptable state sequences (e.g., a plurality of spatiotemporal location sequences), the plurality of state sequences associated with (e.g., defining) a plurality of trajectories. In an example, routes 106 include only high level actions or imprecise state locations, such as a series of connected roads dictating turning directions at roadway intersections. Additionally, or alternatively, routes 106 may include more precise actions or states such as, for example, specific target lanes or precise locations within the lane areas and targeted speed at those positions. In an example, routes 106 include a plurality of precise state sequences along the at least one high level action sequence with a limited lookahead horizon to reach intermediate goals, where the combination of successive iterations of limited horizon state sequences cumulatively correspond to a plurality of trajectories that collectively form the high level route to terminate at the final goal state or region.

Area 108 includes a physical area (e.g., a geographic region) within which vehicles 102 can navigate. In an example, area 108 includes at least one state (e.g., a country, a province, an individual state of a plurality of states included in a country, etc.), at least one portion of a state, at least one city, at least one portion of a city, etc. In some embodiments, area 108 includes at least one named thoroughfare (referred to herein as a “road”) such as a highway, an interstate highway, a parkway, a city street, etc. Additionally, or alternatively, in some examples area 108 includes at least one unnamed road such as a driveway, a section of a parking lot, a section of a vacant and/or undeveloped lot, a dirt path, etc. In some embodiments, a road includes at least one lane (e.g., a portion of the road that can be traversed by vehicles 102). In an example, a road includes at least one lane associated with (e.g., identified based on) at least one lane marking.

Vehicle-to-Infrastructure (V2I) device 110 (sometimes referred to as a Vehicle-to-Infrastructure or Vehicle-to-Everything (V2X) device) includes at least one device configured to be in communication with vehicles 102 and/or V2I infrastructure system 118. In some embodiments, V2I device 110 is configured to be in communication with vehicles 102, remote AV system 114, fleet management system 116, and/or V2I system 118 via network 112. In some embodiments, V2I device 110 includes a radio frequency identification (RFID) device, signage, cameras (e.g., two-dimensional (2D) and/or three-dimensional (3D) cameras), lane markers, streetlights, parking meters, etc. In some embodiments, V2I device 110 is configured to communicate directly with vehicles 102. Additionally, or alternatively, in some embodiments V2I device 110 is configured to communicate with vehicles 102, remote AV system 114, and/or fleet management system 116 via V2I system 118. In some embodiments, V2I device 110 is configured to communicate with V2I system 118 via network 112.

Network 112 includes one or more wired and/or wireless networks. In an example, network 112 includes a cellular network (e.g., a long term evolution (LTE) network, a third generation (3G) network, a fourth generation (4G) network, a fifth generation (5G) network, a code division multiple access (CDMA) network, etc.), a public land mobile network (PLMN), a local area network (LAN), a wide area network (WAN), a metropolitan area network (MAN), a telephone network (e.g., the public switched telephone network (PSTN), a private network, an ad hoc network, an intranet, the Internet, a fiber optic-based network, a cloud computing network, etc., a combination of some or all of these networks, and/or the like.

Remote AV system 114 includes at least one device configured to be in communication with vehicles 102, V2I device 110, network 112, fleet management system 116, and/or V2I system 118 via network 112. In an example, remote AV system 114 includes a server, a group of servers, and/or other like devices. In some embodiments, remote AV system 114 is co-located with the fleet management system 116. In some embodiments, remote AV system 114 is involved in the installation of some or all of the components of a vehicle, including an autonomous system, an autonomous vehicle compute, software implemented by an autonomous vehicle compute, and/or the like. In some embodiments, remote AV system 114 maintains (e.g., updates and/or replaces) such components and/or software during the lifetime of the vehicle.

Fleet management system 116 includes at least one device configured to be in communication with vehicles 102, V2I device 110, remote AV system 114, and/or V2I infrastructure system 118. In an example, fleet management system 116 includes a server, a group of servers, and/or other like devices. In some embodiments, fleet management system 116 is associated with a ridesharing company (e.g., an organization that controls operation of multiple vehicles (e.g., vehicles that include autonomous systems and/or vehicles that do not include autonomous systems) and/or the like).

In some embodiments, V2I system 118 includes at least one device configured to be in communication with vehicles 102, V2I device 110, remote AV system 114, and/or fleet management system 116 via network 112. In some examples, V2I system 118 is configured to be in communication with V2I device 110 via a connection different from network 112. In some embodiments, V2I system 118 includes a server, a group of servers, and/or other like devices. In some embodiments, V2I system 118 is associated with a municipality or a private institution (e.g., a private institution that maintains V2I device 110 and/or the like).

The number and arrangement of elements illustrated in FIG. 1 are provided as an example. There can be additional elements, fewer elements, different elements, and/or differently arranged elements, than those illustrated in FIG. 1. Additionally, or alternatively, at least one element of environment 100 can perform one or more functions described as being performed by at least one different element of FIG. 1. Additionally, or alternatively, at least one set of elements of environment 100 can perform one or more functions described as being performed by at least one different set of elements of environment 100.

Referring now to FIG. 2, vehicle 200 (which may be the same as, or similar to vehicle 102 of FIG. 1) includes or is associated with autonomous system 202, powertrain control system 204, steering control system 206, and brake system 208. In some embodiments, vehicle 200 is the same as or similar to vehicle 102 (see FIG. 1). In some embodiments, autonomous system 202 is configured to confer vehicle 200 autonomous driving capability (e.g., implement at least one driving automation or maneuver-based function, feature, device, and/or the like that enable vehicle 200 to be partially or fully operated without human intervention including, without limitation, fully autonomous vehicles (e.g., vehicles that forego reliance on human intervention such as Level 5 ADS-operated vehicles), highly autonomous vehicles (e.g., vehicles that forego reliance on human intervention in certain situations such as Level 4 ADS-operated vehicles), conditional autonomous vehicles (e.g., vehicles that forego reliance on human intervention in limited situations such as Level 3 ADS-operated vehicles) and/or the like. In one embodiment, autonomous system 202 includes operational or tactical functionality required to operate vehicle 200 in on-road traffic and perform part or all of Dynamic Driving Task (DDT) on a sustained basis. In another embodiment, autonomous system 202 includes an Advanced Driver Assistance System (ADAS) that includes driver support features. Autonomous system 202 supports various levels of driving automation, ranging from no driving automation (e.g., Level 0) to full driving automation (e.g., Level 5). For a detailed description of fully autonomous vehicles and highly autonomous vehicles, reference may be made to SAE International's standard J3016: Taxonomy and Definitions for Terms Related to On-Road Motor Vehicle Automated Driving Systems, which is incorporated by reference in its entirety. In some embodiments, vehicle 200 is associated with an autonomous fleet manager and/or a ridesharing company.

Autonomous system 202 includes a sensor suite that includes one or more devices such as cameras 202a, LiDAR sensors 202b, radar sensors 202c, and microphones 202d. In some embodiments, autonomous system 202 can include more or fewer devices and/or different devices (e.g., ultrasonic sensors, inertial sensors, GPS receivers (discussed below), odometry sensors that generate data associated with an indication of a distance that vehicle 200 has traveled, and/or the like). In some embodiments, autonomous system 202 uses the one or more devices included in autonomous system 202 to generate data associated with environment 100, described herein. The data generated by the one or more devices of autonomous system 202 can be used by one or more systems described herein to observe the environment (e.g., environment 100) in which vehicle 200 is located. In some embodiments, autonomous system 202 includes communication device 202e, autonomous vehicle compute 202f, drive-by-wire (DBW) system 202h, and safety controller 202g.

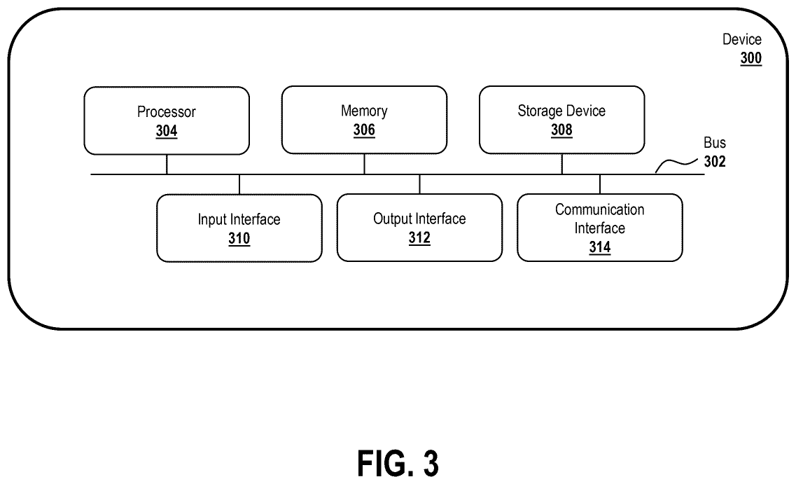

Cameras 202a include at least one device configured to be in communication with communication device 202e, autonomous vehicle compute 202f, and/or safety controller 202g via a bus (e.g., a bus that is the same as or similar to bus 302 of FIG. 3). Cameras 202a include at least one camera (e.g., a digital camera using a light sensor such as a C harge-C oupled D evice (CCD), a thermal camera, an infrared (IR) camera, an event camera, and/or the like) to capture images including physical objects (e.g., cars, buses, curbs, people, and/or the like). In some embodiments, camera 202a generates camera data as output. In some examples, camera 202a generates camera data that includes image data associated with an image. In this example, the image data may specify at least one parameter (e.g., image characteristics such as exposure, brightness, etc., an image timestamp, and/or the like) corresponding to the image. In such an example, the image may be in a format (e.g., RAW, JPEG, PNG, and/or the like). In some embodiments, camera 202a includes a plurality of independent cameras configured on (e.g., positioned on) a vehicle to capture images for the purpose of stereopsis (stereo vision). In some examples, camera 202a includes a plurality of cameras that generate image data and transmit the image data to autonomous vehicle compute 202f and/or a fleet management system (e.g., a fleet management system that is the same as or similar to fleet management system 116 of FIG. 1). In such an example, autonomous vehicle compute 202f determines depth to one or more objects in a field of view of at least two cameras of the plurality of cameras based on the image data from the at least two cameras. In some embodiments, cameras 202a is configured to capture images of objects within a distance from cameras 202a (e.g., up to 100 meters, up to a kilometer, and/or the like). Accordingly, cameras 202a include features such as sensors and lenses that are optimized for perceiving objects that are at one or more distances from cameras 202a.

In an embodiment, camera 202a includes at least one camera configured to capture one or more images associated with one or more traffic lights, street signs and/or other physical objects that provide visual navigation information. In some embodiments, camera 202a generates traffic light data associated with one or more images. In some examples, camera 202a generates TLD (Traffic Light Detection) data associated with one or more images that include a format (e.g., RAW, JPEG, PNG, and/or the like). In some embodiments, camera 202a that generates TLD data differs from other systems described herein incorporating cameras in that camera 202a can include one or more cameras with a wide field of view (e.g., a wide-angle lens, a fish-eye lens, a lens having a viewing angle of approximately 120 degrees or more, and/or the like) to generate images about as many physical objects as possible.

Light Detection and Ranging (LiDAR) sensors 202b include at least one device configured to be in communication with communication device 202e, autonomous vehicle compute 202f, and/or safety controller 202g via a bus (e.g., a bus that is the same as or similar to bus 302 of FIG. 3). LiDAR sensors 202b include a system configured to transmit light from a light emitter (e.g., a laser transmitter). Light emitted by LiDAR sensors 202b include light (e.g., infrared light and/or the like) that is outside of the visible spectrum. In some embodiments, during operation, light emitted by LiDAR sensors 202b encounters a physical object (e.g., a vehicle) and is reflected back to LiDAR sensors 202b. In some embodiments, the light emitted by LiDAR sensors 202b does not penetrate the physical objects that the light encounters. LiDAR sensors 202b also include at least one light detector which detects the light that was emitted from the light emitter after the light encounters a physical object. In some embodiments, at least one data processing system associated with LiDAR sensors 202b generates an image (e.g., a point cloud, a combined point cloud, and/or the like) representing the objects included in a field of view of LiDAR sensors 202b. In some examples, the at least one data processing system associated with LiDAR sensor 202b generates an image that represents the boundaries of a physical object, the surfaces (e.g., the topology of the surfaces) of the physical object, and/or the like. In such an example, the image is used to determine the boundaries of physical objects in the field of view of LiDAR sensors 202b.

Radio Detection and Ranging (radar) sensors 202c include at least one device configured to be in communication with communication device 202e, autonomous vehicle compute 202f, and/or safety controller 202g via a bus (e.g., a bus that is the same as or similar to bus 302 of FIG. 3). Radar sensors 202c include a system configured to transmit radio waves (either pulsed or continuously). The radio waves transmitted by radar sensors 202c include radio waves that are within a predetermined spectrum In some embodiments, during operation, radio waves transmitted by radar sensors 202c encounter a physical object and are reflected back to radar sensors 202c. In some embodiments, the radio waves transmitted by radar sensors 202c are not reflected by some objects. In some embodiments, at least one data processing system associated with radar sensors 202c generates signals representing the objects included in a field of view of radar sensors 202c. For example, the at least one data processing system associated with radar sensor 202c generates an image that represents the boundaries of a physical object, the surfaces (e.g., the topology of the surfaces) of the physical object, and/or the like. In some examples, the image is used to determine the boundaries of physical objects in the field of view of radar sensors 202c.

Microphones 202d includes at least one device configured to be in communication with communication device 202e, autonomous vehicle compute 202f, and/or safety controller 202g via a bus (e.g., a bus that is the same as or similar to bus 302 of FIG. 3). Microphones 202d include one or more microphones (e.g., array microphones, external microphones, and/or the like) that capture audio signals and generate data associated with (e.g., representing) the audio signals. In some examples, microphones 202d include transducer devices and/or like devices. In some embodiments, one or more systems described herein can receive the data generated by microphones 202d and determine a position of an object relative to vehicle 200 (e.g., a distance and/or the like) based on the audio signals associated with the data.

Communication device 202e includes at least one device configured to be in communication with cameras 202a, LiDAR sensors 202b, radar sensors 202c, microphones 202d, autonomous vehicle compute 202f, safety controller 202g, and/or DBW (Drive-By-Wire) system 202h. For example, communication device 202e may include a device that is the same as or similar to communication interface 314 of FIG. 3. In some embodiments, communication device 202e includes a vehicle-to-vehicle (V2V) communication device (e.g., a device that enables wireless communication of data between vehicles).

Autonomous vehicle compute 202f include at least one device configured to be in communication with cameras 202a, LiDAR sensors 202b, radar sensors 202c, microphones 202d, communication device 202e, safety controller 202g, and/or DBW system 202h. In some examples, autonomous vehicle compute 202f includes a device such as a client device, a mobile device (e.g., a cellular telephone, a tablet, and/or the like), a server (e.g., a computing device including one or more central processing units, graphical processing units, and/or the like), and/or the like. In some embodiments, autonomous vehicle compute 202f is the same as or similar to autonomous vehicle compute 400, described herein. Additionally, or alternatively, in some embodiments autonomous vehicle compute 202f is configured to be in communication with an autonomous vehicle system (e.g., an autonomous vehicle system that is the same as or similar to remote AV system 114 of FIG. 1), a fleet management system (e.g., a fleet management system that is the same as or similar to fleet management system 116 of FIG. 1), a V2I device (e.g., a V2I device that is the same as or similar to V2I device 110 of FIG. 1), and/or a V2I system (e.g., a V2I system that is the same as or similar to V2I system 118 of FIG. 1).

Safety controller 202g includes at least one device configured to be in communication with cameras 202a, LiDAR sensors 202b, radar sensors 202c, microphones 202d, communication device 202e, autonomous vehicle computer 202f, and/or DBW system 202h. In some examples, safety controller 202g includes one or more controllers (electrical controllers, electromechanical controllers, and/or the like) that are configured to generate and/or transmit control signals to operate one or more devices of vehicle 200 (e.g., powertrain control system 204, steering control system 206, brake system 208, and/or the like). In some embodiments, safety controller 202g is configured to generate control signals that take precedence over (e.g., overrides) control signals generated and/or transmitted by autonomous vehicle compute 202f.

DBW system 202h includes at least one device configured to be in communication with communication device 202e and/or autonomous vehicle compute 202f. In some examples, DBW system 202h includes one or more controllers (e.g., electrical controllers, electromechanical controllers, and/or the like) that are configured to generate and/or transmit control signals to operate one or more devices of vehicle 200 (e.g., powertrain control system 204, steering control system 206, brake system 208, and/or the like). Additionally, or alternatively, the one or more controllers of DBW system 202h are configured to generate and/or transmit control signals to operate at least one different device (e.g., a turn signal, headlights, door locks, windshield wipers, and/or the like) of vehicle 200.

Powertrain control system 204 includes at least one device configured to be in communication with DBW system 202h. In some examples, powertrain control system 204 includes at least one controller, actuator, and/or the like. In some embodiments, powertrain control system 204 receives control signals from DBW system 202h and powertrain control system 204 causes vehicle 200 to make longitudinal vehicle motion, such as start moving forward, stop moving forward, start moving backward, stop moving backward, accelerate in a direction, decelerate in a direction or to make lateral vehicle motion such as performing a left turn, performing a right turn, and/or the like. In an example, powertrain control system 204 causes the energy (e.g., fuel, electricity, and/or the like) provided to a motor of the vehicle to increase, remain the same, or decrease, thereby causing at least one wheel of vehicle 200 to rotate or not rotate.

Steering control system 206 includes at least one device configured to rotate one or more wheels of vehicle 200. In some examples, steering control system 206 includes at least one controller, actuator, and/or the like. In some embodiments, steering control system 206 causes the front two wheels and/or the rear two wheels of vehicle 200 to rotate to the left or right to cause vehicle 200 to turn to the left or right. In other words, steering control system 206 causes activities necessary for the regulation of the y-axis component of vehicle motion.

Brake system 208 includes at least one device configured to actuate one or more brakes to cause vehicle 200 to reduce speed and/or remain stationary. In some examples, brake system 208 includes at least one controller and/or actuator that is configured to cause one or more calipers associated with one or more wheels of vehicle 200 to close on a corresponding rotor of vehicle 200. Additionally, or alternatively, in some examples brake system 208 includes an automatic emergency braking (AEB) system, a regenerative braking system, and/or the like)

In some embodiments, vehicle 200 includes at least one platform sensor (not explicitly illustrated) that measures or infers properties of a state or a condition of vehicle 200. In some examples, vehicle 200 includes platform sensors such as a global positioning system (GPS) receiver, an inertial measurement unit (IMU), a wheel speed sensor, a wheel brake pressure sensor, a wheel torque sensor, an engine torque sensor, a steering angle sensor, and/or the like. Although brake system 208 is illustrated to be located in the near side of vehicle 200 in FIG. 2, brake system 208 may be located anywhere in vehicle 200.

Referring now to FIG. 3, illustrated is a schematic diagram of a device 300. As illustrated, device 300 includes processor 304, memory 306, storage component 308, input interface 310, output interface 312, communication interface 314, and bus 302. In some embodiments, device 300 corresponds to at least one device of vehicles 102 (e.g., at least one device of a system of vehicles 102), and/or one or more devices of network 112 (e.g., one or more devices of a system of network 112). In some embodiments, one or more devices of vehicles 102 (e.g., one or more devices of a system of vehicles 102), and/or one or more devices of network 112 (e.g., one or more devices of a system of network 112) include at least one device 300 and/or at least one component of device 300. As shown in FIG. 3, device 300 includes bus 302, processor 304, memory 306, storage component 308, input interface 310, output interface 312, and communication interface 314.

Bus 302 includes a component that permits communication among the components of device 300. In some cases, processor 304 includes a processor (e.g., a central processing unit (CPU), a graphics processing unit (GPU), an accelerated processing unit (APU), and/or the like), a microphone, a digital signal processor (DSP), and/or any processing component (e.g., a field-programmable gate array (FPGA), an application specific integrated circuit (ASIC), and/or the like) that can be programmed to perform at least one function. Memory 306 includes random access memory (RAM), read-only memory (ROM), and/or another type of dynamic and/or static storage device (e.g., flash memory, magnetic memory, optical memory, and/or the like) that stores data and/or instructions for use by processor 304.

Storage component 308 stores data and/or software related to the operation and use of device 300. In some examples, storage component 308 includes a hard disk (e.g., a magnetic disk, an optical disk, a magneto-optic disk, a solid state disk, and/or the like), a compact disc (CD), a digital versatile disc (DVD), a floppy disk, a cartridge, a magnetic tape, a CD-ROM, RAM, PROM, EPROM, FLASH-EPROM, NV-RAM, and/or another type of computer readable medium, along with a corresponding drive.

Input interface 310 includes a component that permits device 300 to receive information, such as via user input (e.g., a touchscreen display, a keyboard, a keypad, a mouse, a button, a switch, a microphone, a camera, and/or the like). Additionally or alternatively, in some embodiments input interface 310 includes a sensor that senses information (e.g., a global positioning system (GPS) receiver, an accelerometer, a gyroscope, an actuator, and/or the like). Output interface 312 includes a component that provides output information from device 300 (e.g., a display, a speaker, one or more light-emitting diodes (LEDs), and/or the like).

In some embodiments, communication interface 314 includes a transceiver-like component (e.g., a transceiver, a separate receiver and transmitter, and/or the like) that permits device 300 to communicate with other devices via a wired connection, a wireless connection, or a combination of wired and wireless connections. In some examples, communication interface 314 permits device 300 to receive information from another device and/or provide information to another device. In some examples, communication interface 314 includes an Ethernet interface, an optical interface, a coaxial interface, an infrared interface, a radio frequency (RF) interface, a universal serial bus (USB) interface, a Wi-Fi® interface, a cellular network interface, and/or the like.

In some embodiments, device 300 performs one or more processes described herein. Device 300 performs these processes based on processor 304 executing software instructions stored by a computer-readable medium, such as memory 305 and/or storage component 308. A computer-readable medium (e.g., a non-transitory computer readable medium) is defined herein as a non-transitory memory device. A non-transitory memory device includes memory space located inside a single physical storage device or memory space spread across multiple physical storage devices.

In some embodiments, software instructions are read into memory 306 and/or storage component 308 from another computer-readable medium or from another device via communication interface 314. When executed, software instructions stored in memory 306 and/or storage component 308 cause processor 304 to perform one or more processes described herein. Additionally or alternatively, hardwired circuitry is used in place of or in combination with software instructions to perform one or more processes described herein. Thus, embodiments described herein are not limited to any specific combination of hardware circuitry and software unless explicitly stated otherwise.

Memory 306 and/or storage component 308 includes data storage or at least one data structure (e.g., a database and/or the like). Device 300 is capable of receiving information from, storing information in, communicating information to, or searching information stored in the data storage or the at least one data structure in memory 306 or storage component 308. In some examples, the information includes network data, input data, output data, or any combination thereof.

In some embodiments, device 300 is configured to execute software instructions that are either stored in memory 306 and/or in the memory of another device (e.g., another device that is the same as or similar to device 300). As used herein, the term “module” refers to at least one instruction stored in memory 306 and/or in the memory of another device that, when executed by processor 304 and/or by a processor of another device (e.g., another device that is the same as or similar to device 300) cause device 300 (e.g., at least one component of device 300) to perform one or more processes described herein. In some embodiments, a module is implemented in software, firmware, hardware, and/or the like.

The number and arrangement of components illustrated in FIG. 3 are provided as an example. In some embodiments, device 300 can include additional components, fewer components, different components, or differently arranged components than those illustrated in FIG. 3. Additionally or alternatively, a set of components (e.g., one or more components) of device 300 can perform one or more functions described as being performed by another component or another set of components of device 300.

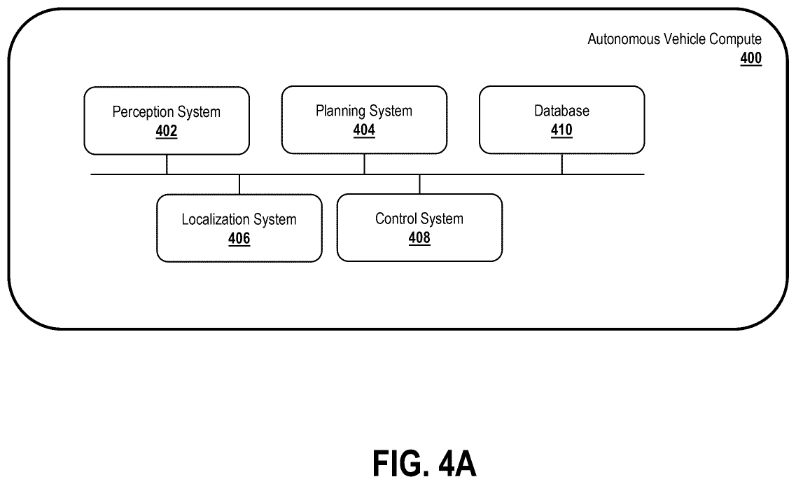

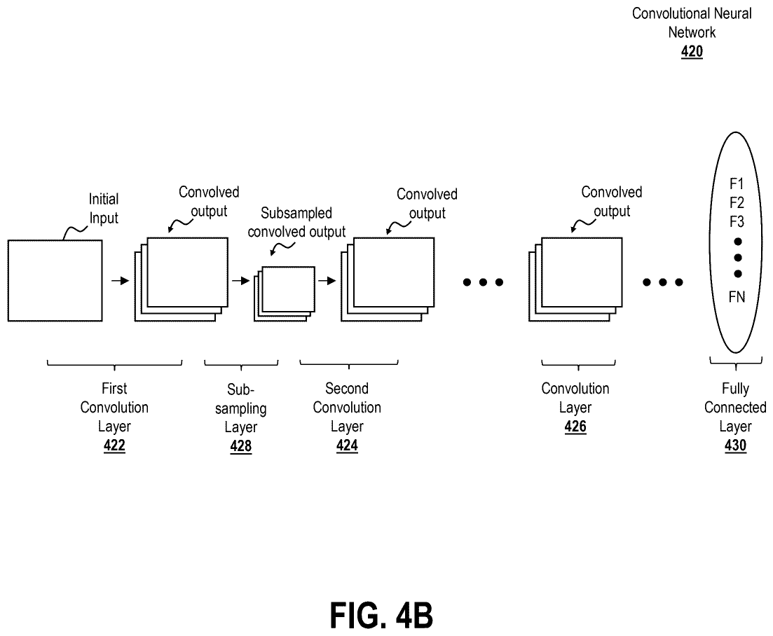

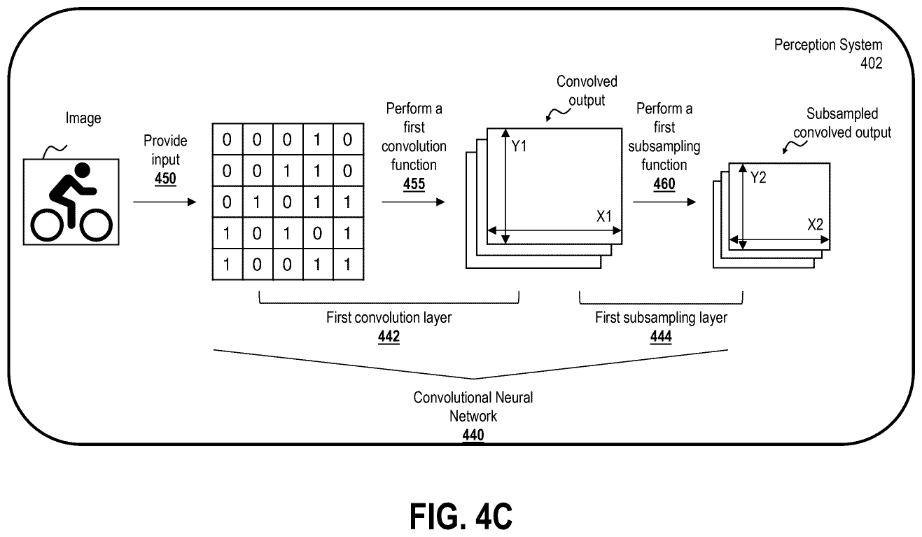

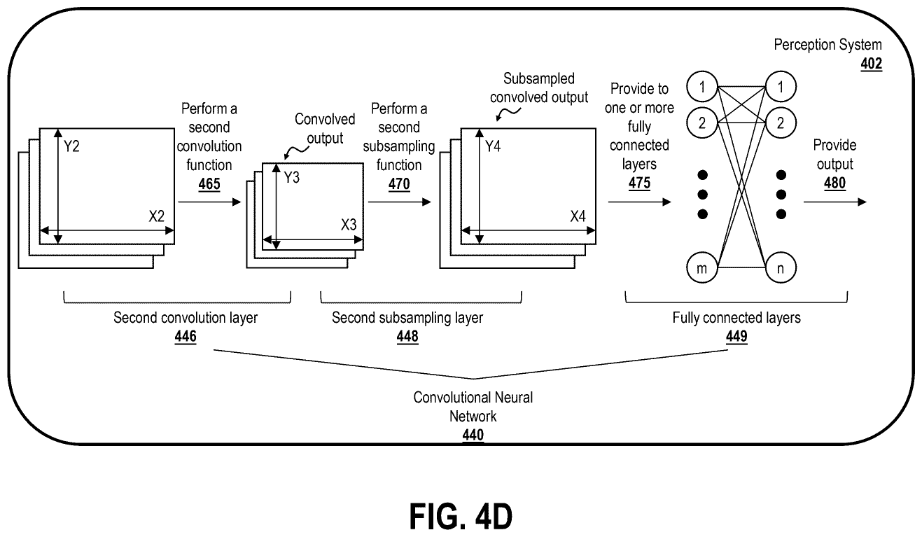

Referring now to FIG. 4, illustrated is an example block diagram of an autonomous vehicle compute 400 (sometimes referred to as an “AV stack”). As illustrated, autonomous vehicle compute 400 includes perception system 402 (sometimes referred to as a perception module), planning system 404 (sometimes referred to as a planning module), localization system 406 (sometimes referred to as a localization module), control system 408 (sometimes referred to as a control module), and database 410. In some embodiments, perception system 402, planning system 404, localization system 406, control system 408, and database 410 are included and/or implemented in an autonomous navigation system of a vehicle (e.g., autonomous vehicle compute 202f of vehicle 200). Additionally, or alternatively, in some embodiments perception system 402, planning system 404, localization system 406, control system 408, and database 410 are included in one or more standalone systems (e.g., one or more systems that are the same as or similar to autonomous vehicle compute 400 and/or the like). In some examples, perception system 402, planning system 404, localization system 406, control system 408, and database 410 are included in one or more standalone systems that are located in a vehicle and/or at least one remote system as described herein. In some embodiments, any and/or all of the systems included in autonomous vehicle compute 400 are implemented in software (e.g., in software instructions stored in memory), computer hardware (e.g., by microprocessors, microcontrollers, application-specific integrated circuits (ASICs), Field Programmable Gate Arrays (FPGAs), and/or the like), or combinations of computer software and computer hardware. It will also be understood that, in some embodiments, autonomous vehicle compute 400 is configured to be in communication with a remote system (e.g., an autonomous vehicle system that is the same as or similar to remote AV system 114, a fleet management system 116 that is the same as or similar to fleet management system 116, a V2I system that is the same as or similar to V2I system 118, and/or the like).

In some embodiments, perception system 402 receives data associated with at least one physical object (e.g., data that is used by perception system 402 to detect the at least one physical object) in an environment and classifies the at least one physical object. In some examples, perception system 402 receives image data captured by at least one camera (e.g., cameras 202a), the image associated with (e.g., representing) one or more physical objects within a field of view of the at least one camera. In such an example, perception system 402 classifies at least one physical object based on one or more groupings of physical objects (e.g., bicycles, vehicles, traffic signs, pedestrians, and/or the like). In some embodiments, perception system 402 transmits data associated with the classification of the physical objects to planning system 404 based on perception system 402 classifying the physical objects.

In some embodiments, planning system 404 receives data associated with a destination and generates data associated with at least one route (e.g., routes 106) along which a vehicle (e.g., vehicles 102) can travel along toward a destination. In some embodiments, planning system 404 periodically or continuously receives data from perception system 402 (e.g., data associated with the classification of physical objects, described above) and planning system 404 updates the at least one trajectory or generates at least one different trajectory based on the data generated by perception system 402. In other words, planning system 404 may perform tactical function-related tasks that are required to operate vehicle 102 in on-road traffic. Tactical efforts involve maneuvering the vehicle in traffic during a trip, including but not limited to deciding whether and when to overtake another vehicle, change lanes, or selecting an appropriate speed, acceleration, deacceleration, etc. In some embodiments, planning system 404 receives data associated with an updated position of a vehicle (e.g., vehicles 102) from localization system 406 and planning system 404 updates the at least one trajectory or generates at least one different trajectory based on the data generated by localization system 406.

In some embodiments, localization system 406 receives data associated with (e.g., representing) a location of a vehicle (e.g., vehicles 102) in an area. In some examples, localization system 406 receives LiDAR data associated with at least one point cloud generated by at least one LiDAR sensor (e.g., LiDAR sensors 202b). In certain examples, localization system 406 receives data associated with at least one point cloud from multiple LiDAR sensors and localization system 406 generates a combined point cloud based on each of the point clouds. In these examples, localization system 406 compares the at least one point cloud or the combined point cloud to two-dimensional (2D) and/or a three-dimensional (3D) map of the area stored in database 410. Localization system 406 then determines the position of the vehicle in the area based on localization system 406 comparing the at least one point cloud or the combined point cloud to the map. In some embodiments, the map includes a combined point cloud of the area generated prior to navigation of the vehicle. In some embodiments, maps include, without limitation, high-precision maps of the roadway geometric properties, maps describing road network connectivity properties, maps describing roadway physical properties (such as traffic speed, traffic volume, the number of vehicular and cyclist traffic lanes, lane width, lane traffic directions, or lane marker types and locations, or combinations thereof), and maps describing the spatial locations of road features such as crosswalks, traffic signs or other travel signals of various types. In some embodiments, the map is generated in real-time based on the data received by the perception system.

In another example, localization system 406 receives Global Navigation Satellite System (GNSS) data generated by a global positioning system (GPS) receiver. In some examples, localization system 406 receives GNSS data associated with the location of the vehicle in the area and localization system 406 determines a latitude and longitude of the vehicle in the area. In such an example, localization system 406 determines the position of the vehicle in the area based on the latitude and longitude of the vehicle. In some embodiments, localization system 406 generates data associated with the position of the vehicle. In some examples, localization system 406 generates data associated with the position of the vehicle based on localization system 406 determining the position of the vehicle. In such an example, the data associated with the position of the vehicle includes data associated with one or more semantic properties corresponding to the position of the vehicle.

In some embodiments, control system 408 receives data associated with at least one trajectory from planning system 404 and control system 408 controls operation of the vehicle. In some examples, control system 408 receives data associated with at least one trajectory from planning system 404 and control system 408 controls operation of the vehicle by generating and transmitting control signals to cause a powertrain control system (e.g., DBW system 202h, powertrain control system 204, and/or the like), a steering control system (e.g., steering control system 206), and/or a brake system (e.g., brake system 208) to operate. For example, control system 408 is configured to perform operational functions such as a lateral vehicle motion control or a longitudinal vehicle motion control. The lateral vehicle motion control causes activities necessary for the regulation of the y-axis component of vehicle motion. The longitudinal vehicle motion control causes activities necessary for the regulation of the x-axis component of vehicle motion. In an example, where a trajectory includes a left turn, control system 408 transmits a control signal to cause steering control system 206 to adjust a steering angle of vehicle 200, thereby causing vehicle 200 to turn left. Additionally, or alternatively, control system 408 generates and transmits control signals to cause other devices (e.g., headlights, turn signal, door locks, windshield wipers, and/or the like) of vehicle 200 to change states.

In some embodiments, perception system 402, planning system 404, localization system 406, and/or control system 408 implement at least one machine learning model (e.g., at least one multilayer perceptron (MLP), at least one convolutional neural network (CNN), at least one recurrent neural network (RNN), at least one autoencoder, at least one transformer, and/or the like). In some examples, perception system 402, planning system 404, localization system 406, and/or control system 408 implement at least one machine learning model alone or in combination with one or more of the above-noted systems. In some examples, perception system 402, planning system 404, localization system 406, and/or control system 408 implement at least one machine learning model as part of a pipeline (e.g., a pipeline for identifying one or more objects located in an environment and/or the like). An example of an implementation of a convolutional neural network is included below with respect to FIGS. 4B-4D.

Database 410 stores data that is transmitted to, received from, and/or updated by perception system 402, planning system 404, localization system 406 and/or control system 408. In some examples, database 410 includes a storage component (e.g., a storage component that is the same as or similar to storage component 308 of FIG. 3) that stores data and/or software related to the operation and uses at least one system of autonomous vehicle compute 400. In some embodiments, database 410 stores data associated with 2D and/or 3D maps of at least one area. In some examples, database 410 stores data associated with 2D and/or 3D maps of a portion of a city, multiple portions of multiple cities, multiple cities, a county, a state, a State (e.g., a country), and/or the like). In such an example, a vehicle (e.g., a vehicle that is the same as or similar to vehicles 102 and/or vehicle 200) can drive along one or more drivable regions (e.g., single-lane roads, multi-lane roads, highways, back roads, off road trails, and/or the like) and cause at least one LiDAR sensor (e.g., a LiDAR sensor that is the same as or similar to LiDAR sensors 202b) to generate data associated with an image representing the objects included in a field of view of the at least one LiDAR sensor.

In some embodiments, database 410 can be implemented across a plurality of devices. In some examples, database 410 is included in a vehicle (e.g., a vehicle that is the same as or similar to vehicles 102 and/or vehicle 200), an autonomous vehicle system (e.g., an autonomous vehicle system that is the same as or similar to remote AV system 114, a fleet management system (e.g., a fleet management system that is the same as or similar to fleet management system 116 of FIG. 1, a V2I system (e.g., a V2I system that is the same as or similar to V2I system 118 of FIG. 1) and/or the like.

Referring now to FIG. 4B, illustrated is a diagram of an implementation of a machine learning model. More specifically, illustrated is a diagram of an implementation of a convolutional neural network (CNN) 420. For purposes of illustration, the following description of CNN 420 will be with respect to an implementation of CNN 420 by perception system 402. However, it will be understood that in some examples CNN 420 (e.g., one or more components of CNN 420) is implemented by other systems different from, or in addition to, perception system 402 such as planning system 404, localization system 406, and/or control system 408. While CNN 420 includes certain features as described herein, these features are provided for the purpose of illustration and are not intended to limit the present disclosure.

CNN 420 includes a plurality of convolution layers including first convolution layer 422, second convolution layer 424, and convolution layer 426. In some embodiments, CNN 420 includes sub-sampling layer 428 (sometimes referred to as a pooling layer). In some embodiments, sub-sampling layer 428 and/or other subsampling layers have a dimension (i.e., an amount of nodes) that is less than a dimension of an upstream system. By virtue of sub-sampling layer 428 having a dimension that is less than a dimension of an upstream layer, CNN 420 consolidates the amount of data associated with the initial input and/or the output of an upstream layer to thereby decrease the amount of computations necessary for CNN 420 to perform downstream convolution operations. Additionally, or alternatively, by virtue of sub-sampling layer 428 being associated with (e.g., configured to perform) at least one subsampling function (as described below with respect to FIGS. 4C and 4D), CNN 420 consolidates the amount of data associated with the initial input.

Perception system 402 performs convolution operations based on perception system 402 providing respective inputs and/or outputs associated with each of first convolution layer 422, second convolution layer 424, and convolution layer 426 to generate respective outputs. In some examples, perception system 402 implements CNN 420 based on perception system 402 providing data as input to first convolution layer 422, second convolution layer 424, and convolution layer 426. In such an example, perception system 402 provides the data as input to first convolution layer 422, second convolution layer 424, and convolution layer 426 based on perception system 402 receiving data from one or more different systems (e.g., one or more systems of a vehicle that is the same as or similar to vehicle 102), a remote AV system that is the same as or similar to remote AV system 114, a fleet management system that is the same as or similar to fleet management system 116, a V2I system that is the same as or similar to V2I system 118, and/or the like). A detailed description of convolution operations is included below with respect to FIG. 4C.

In some embodiments, perception system 402 provides data associated with an input (referred to as an initial input) to first convolution layer 422 and perception system 402 generates data associated with an output using first convolution layer 422. In some embodiments, perception system 402 provides an output generated by a convolution layer as input to a different convolution layer. For example, perception system 402 provides the output of first convolution layer 422 as input to sub-sampling layer 428, second convolution layer 424, and/or convolution layer 426. In such an example, first convolution layer 422 is referred to as an upstream layer and sub-sampling layer 428, second convolution layer 424, and/or convolution layer 426 are referred to as downstream layers. Similarly, in some embodiments perception system 402 provides the output of sub-sampling layer 428 to second convolution layer 424 and/or convolution layer 426 and, in this example, sub-sampling layer 428 would be referred to as an upstream layer and second convolution layer 424 and/or convolution layer 426 would be referred to as downstream layers.

In some embodiments, perception system 402 processes the data associated with the input provided to CNN 420 before perception system 402 provides the input to CNN 420. For example, perception system 402 processes the data associated with the input provided to CNN 420 based on perception system 402 normalizing sensor data (e.g., image data, LiDAR data, radar data, and/or the like).

In some embodiments, CNN 420 generates an output based on perception system 402 performing convolution operations associated with each convolution layer. In some examples, CNN 420 generates an output based on perception system 402 performing convolution operations associated with each convolution layer and an initial input. In some embodiments, perception system 402 generates the output and provides the output as fully connected layer 430. In some examples, perception system 402 provides the output of convolution layer 426 as fully connected layer 430, where fully connected layer 430 includes data associated with a plurality of feature values referred to as F1, F2 . . . FN. In this example, the output of convolution layer 426 includes data associated with a plurality of output feature values that represent a prediction.

In some embodiments, perception system 402 identifies a prediction from among a plurality of predictions based on perception system 402 identifying a feature value that is associated with the highest likelihood of being the correct prediction from among the plurality of predictions. For example, where fully connected layer 430 includes feature values F1, F2, . . . FN, and F1 is the greatest feature value, perception system 402 identifies the prediction associated with F1 as being the correct prediction from among the plurality of predictions. In some embodiments, perception system 402 trains CNN 420 to generate the prediction. In some examples, perception system 402 trains CNN 420 to generate the prediction based on perception system 402 providing training data associated with the prediction to CNN 420.

Referring now to FIGS. 4C and 4D, illustrated is a diagram of example operation of CNN 440 by perception system 402. In some embodiments, CNN 440 (e.g., one or more components of CNN 440) is the same as, or similar to, CNN 420 (e.g., one or more components of CNN 420) (see FIG. 4B).

At step 450, perception system 402 provides data associated with an image as input to CNN 440 (step 450). For example, as illustrated, perception system 402 provides the data associated with the image to CNN 440, where the image is a greyscale image represented as values stored in a two-dimensional (2D) array. In some embodiments, the data associated with the image may include data associated with a color image, the color image represented as values stored in a three-dimensional (3D) array. Additionally, or alternatively, the data associated with the image may include data associated with an infrared image, a radar image, and/or the like.

At step 455, CNN 440 performs a first convolution function. For example, CNN 440 performs the first convolution function based on CNN 440 providing the values representing the image as input to one or more neurons (not explicitly illustrated) included in first convolution layer 442. In this example, the values representing the image can correspond to values representing a region of the image (sometimes referred to as a receptive field). In some embodiments, each neuron is associated with a filter (not explicitly illustrated). A filter (sometimes referred to as a kernel) is representable as an array of values that corresponds in size to the values provided as input to the neuron. In one example, a filter may be configured to identify edges (e.g., horizontal lines, vertical lines, straight lines, and/or the like). In successive convolution layers, the filters associated with neurons may be configured to identify successively more complex patterns (e.g., arcs, objects, and/or the like).

In some embodiments, CNN 440 performs the first convolution function based on CNN 440 multiplying the values provided as input to each of the one or more neurons included in first convolution layer 442 with the values of the filter that corresponds to each of the one or more neurons. For example, CNN 440 can multiply the values provided as input to each of the one or more neurons included in first convolution layer 442 with the values of the filter that corresponds to each of the one or more neurons to generate a single value or an array of values as an output. In some embodiments, the collective output of the neurons of first convolution layer 442 is referred to as a convolved output. In some embodiments, where each neuron has the same filter, the convolved output is referred to as a feature map.

In some embodiments, CNN 440 provides the outputs of each neuron of first convolutional layer 442 to neurons of a downstream layer. For purposes of clarity, an upstream layer can be a layer that transmits data to a different layer (referred to as a downstream layer). For example, CNN 440 can provide the outputs of each neuron of first convolutional layer 442 to corresponding neurons of a subsampling layer. In an example, CNN 440 provides the outputs of each neuron of first convolutional layer 442 to corresponding neurons of first subsampling layer 444. In some embodiments, CNN 440 adds a bias value to the aggregates of all the values provided to each neuron of the downstream layer. For example, CNN 440 adds a bias value to the aggregates of all the values provided to each neuron of first subsampling layer 444. In such an example, CNN 440 determines a final value to provide to each neuron of first subsampling layer 444 based on the aggregates of all the values provided to each neuron and an activation function associated with each neuron of first subsampling layer 444.

At step 460, CNN 440 performs a first subsampling function. For example, CNN 440 can perform a first subsampling function based on CNN 440 providing the values output by first convolution layer 442 to corresponding neurons of first subsampling layer 444. In some embodiments, CNN 440 performs the first subsampling function based on an aggregation function. In an example, CNN 440 performs the first subsampling function based on CNN 440 determining the maximum input among the values provided to a given neuron (referred to as a max pooling function). In another example, CNN 440 performs the first subsampling function based on CNN 440 determining the average input among the values provided to a given neuron (referred to as an average pooling function). In some embodiments, CNN 440 generates an output based on CNN 440 providing the values to each neuron of first subsampling layer 444, the output sometimes referred to as a subsampled convolved output.

At step 465, CNN 440 performs a second convolution function. In some embodiments, CNN 440 performs the second convolution function in a manner similar to how CNN 440 performed the first convolution function, described above. In some embodiments, CNN 440 performs the second convolution function based on CNN 440 providing the values output by first subsampling layer 444 as input to one or more neurons (not explicitly illustrated) included in second convolution layer 446. In some embodiments, each neuron of second convolution layer 446 is associated with a filter, as described above. The filter(s) associated with second convolution layer 446 may be configured to identify more complex patterns than the filter associated with first convolution layer 442, as described above.

In some embodiments, CNN 440 performs the second convolution function based on CNN 440 multiplying the values provided as input to each of the one or more neurons included in second convolution layer 446 with the values of the filter that corresponds to each of the one or more neurons. For example, CNN 440 can multiply the values provided as input to each of the one or more neurons included in second convolution layer 446 with the values of the filter that corresponds to each of the one or more neurons to generate a single value or an array of values as an output.

In some embodiments, CNN 440 provides the outputs of each neuron of second convolutional layer 446 to neurons of a downstream layer. For example, CNN 440 can provide the outputs of each neuron of first convolutional layer 442 to corresponding neurons of a subsampling layer. In an example, CNN 440 provides the outputs of each neuron of first convolutional layer 442 to corresponding neurons of second subsampling layer 448. In some embodiments, CNN 440 adds a bias value to the aggregates of all the values provided to each neuron of the downstream layer. For example, CNN 440 adds a bias value to the aggregates of all the values provided to each neuron of second subsampling layer 448. In such an example, CNN 440 determines a final value to provide to each neuron of second subsampling layer 448 based on the aggregates of all the values provided to each neuron and an activation function associated with each neuron of second subsampling layer 448.

At step 470, CNN 440 performs a second subsampling function. For example, CNN 440 can perform a second subsampling function based on CNN 440 providing the values output by second convolution layer 446 to corresponding neurons of second subsampling layer 448. In some embodiments, CNN 440 performs the second subsampling function based on CNN 440 using an aggregation function. In an example, CNN 440 performs the first subsampling function based on CNN 440 determining the maximum input or an average input among the values provided to a given neuron, as described above. In some embodiments, CNN 440 generates an output based on CNN 440 providing the values to each neuron of second subsampling layer 448.

At step 475, CNN 440 provides the output of each neuron of second subsampling layer 448 to fully connected layers 449. For example, CNN 440 provides the output of each neuron of second subsampling layer 448 to fully connected layers 449 to cause fully connected layers 449 to generate an output. In some embodiments, fully connected layers 449 are configured to generate an output associated with a prediction (sometimes referred to as a classification). The prediction may include an indication that an object included in the image provided as input to CNN 440 includes an object, a set of objects, and/or the like. In some embodiments, perception system 402 performs one or more operations and/or provides the data associated with the prediction to a different system, described herein.

### Obstacle Detection

Autonomous (or semi-autonomous) vehicles may use machine learning models to identify agents (e.g., objects in an environment that may move independently or otherwise, such as vehicles, bicycles, pedestrians, etc.), predict their trajectories, and calculate a path for the vehicle. It is important that the machine learning models accurately detect objects that are in or that enter the path of an autonomous vehicle within an environment, also referred to herein as obstacles. Falsely detecting an obstacle may result in the vehicle taking actions that may increase the likelihood of a collision. For example, if a machine learning model of an autonomous vehicle erroneously detects an obstacle, the vehicle may decelerate quickly, which may result in a collision with a car behind the autonomous vehicle, or the autonomous vehicle may swerve to avoid the identified obstacle, which may increase the likelihood of a collision. Failing to detect an obstacle may result in even worse outcomes, as the autonomous vehicle may collide with the obstacle.

In some cases, a machine learning model may be trained to predict the trajectories agents in an environment using regression. For example, thousands, millions, or billions of scenarios, each including one or more agents, may be presented to the machine learning model. The machine learning model may predict the paths or trajectories for the agents in the scenarios for a period of time (e.g., 6-8 seconds). The predictions for the agents in the scenarios may be compared with ground truth data and an error calculated based on the difference in distance between the generated trajectory and the ground truth data. The machine learning model may use the error to modify its nodes or weights so as to minimize the distance between the predicted trajectories and the ground truth data.

Once trained, it may be difficult to determine the efficacy of the machine learning model (trained using regression) at predicting whether an agent will become an obstacle to the ego vehicle or the likelihood that a path of the agent may cause a collision.

In some cases, when validating a machine learning model, a testing system may compare the predicted trajectory of an agent that is generated by the machine learning model for a particular environment with a previously driven trajectory or ground truth data. The evaluation system may rate the generated trajectory based on the difference in distance between the generated trajectory and the previously driven trajectory. The testing system may evaluate the generated trajectories of the machine learning model millions or billions of times to determine an overall score for the machine learning model. Based on the score, the machine learning model may be approved for use or retrained using different parameters data, etc.

Testing the machine learning model based on a difference in distance between the generated trajectory and the previously driven trajectory may not be sufficient to determine whether a machine learning model will properly identify and adjust to obstacles.

To address these issues, an evaluation system may convert the output of a machine learning regression model of predicting a path of an agent into a classification prediction of whether an agent will be an obstacle. By converting the machine learning regression model into a classification prediction, the accuracy of the machine learning model can be improved. For example, additional features and data can be extracted from the classification-based machine learning prediction in order to identify errors in the machine learning model and determine whether additional or different training should be used. In some cases, to evaluate the machine learning model, the evaluation system may communicate thousands, millions, or billions of scenarios in real time to the machine learning model, receive the predictions for the agents in real-time, convert the regression predictions to classification predictions, and evaluate the classifications in real-time. As such, the evaluation system may communicate and receive millions or billions of machine-learning inputs and outputs in real-time to evaluate the machine learning model and determine its efficacy.

Accordingly, the system described herein allows for the improved accuracy of machine learning models and enables improved fine tuning or training of models. Further, the system may improve the safety of autonomous vehicles by identifying machine learning models best adapted for use in real-time scenarios.

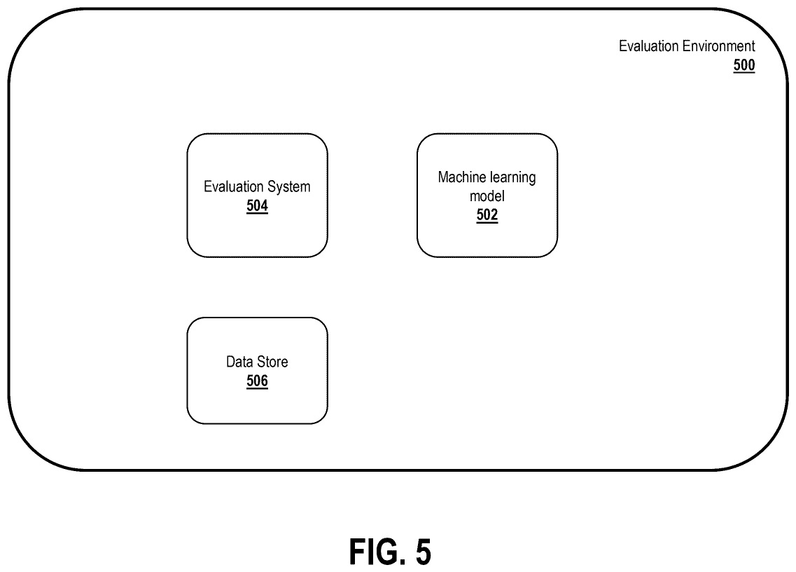

FIG. 5 is a block diagram illustrating an evaluation environment 500 to evaluate a machine learning model's ability to predict an agent as an obstacle. In the illustrated example, the evaluation environment 500 includes a machine learning model 502 that has been trained to predict agent paths or trajectories, an evaluation system 504, and a data store 506. The machine learning model 502, evaluation system 504, and/or the data store 506 may communicate with each other via one or more networks, such as a local area network, wide area network, etc.

The machine learning model 502 may be similar to the machine learning models described herein. For example, the machine learning model may be similar to the CNN 420 described in FIGS. 4B-4D and/or may be implemented using a recurrent neural network, and/or encoder-decoder transformer network, or other machine learning model architectures. Moreover, the machine learning model 502 may be trained to identify agents in images, predict trajectories of those agents, and/or predict a vehicle path of an ego vehicle. As described herein, the machine learning model 502 may be a regression-based model configured to predict trajectories or paths of agents based on known parameters of an agent, such as, but not limited to, location, heading or orientation, velocity, etc.

The evaluation system 504 may be implemented using one or more computing systems and include one or more processors to evaluate the machine learning model 502 as described herein. In some cases, the evaluation system 504 may be implemented using a distributed computing system that uses multiple processors in different locations to evaluate the machine learning model 502. In certain cases, the evaluation system 504 may be implemented using multiple isolated execution environments (e.g., virtual machines, software containers, etc.) in a shared computing environment (e.g., virtualized computing environment).

The data store 506 may be implemented using one or more volatile and/or non-volatile data stores. In some cases, the data store 506 may form part of the evaluation system 504 and the evaluation system 504 may communicate with the data store 506 via a message bus. In certain cases, the data store 506 may be remotely located from the processors of the evaluation system 504 and the evaluation system 504 may communicate with the data store 506 via a network connection.

The data store 506 may be configured to store driving data that corresponds to data collected during navigation of one or more vehicles (autonomous or human driven) through various scenes or environments. The driving data may include ego vehicle data about the driven vehicle itself and/or (historical) scene data related to the scenes/environments through which the ego vehicle travels, or simulated scene data (individually or collectively referred to herein as ground truth data). For example, the ego vehicle data may indicate the ego vehicle's path through the scene, including velocity, acceleration/deceleration, lateral movements, lane changes, etc.

The ground truth data may show the paths or trajectories of agents (e.g., objects expected to move) in the scene, such as but not limited to other vehicles, bicycles, pedestrians, etc. In some cases, the ego vehicle may include cameras, lidar sensors, radar sensors, etc. to collect the ground truth data. For example, as an ego vehicle navigates an environment, one or more sensors may collect data about the ego vehicle and the scene. In certain cases, the ground truth data may include scene data simulated by another computing device.

In some cases, the ground truth data may indicate that a particular agent is an (actual) obstacle to the ego vehicle. For example, the ground truth data may indicate that the particular agent crosses in front of the ego vehicle. In some such cases, the ego vehicle may react to the intersection, for example, by decelerating and/or moving to the right or left. The ego vehicle data may indicate such adjustments to the ego vehicle's path.

As described herein, accurately predicting whether an agent is or will become an obstacle is important for the safety of vehicle passengers. For example, failing to properly predict an obstacle, may result in a collision or injury (e.g., colliding with the agent). Similarly, predicting an agent to be/become an obstacle inaccurately could result in a defensive maneuver (e.g., rapid deceleration or lateral movement) that may also cause a collision (e.g., rear-end collision).

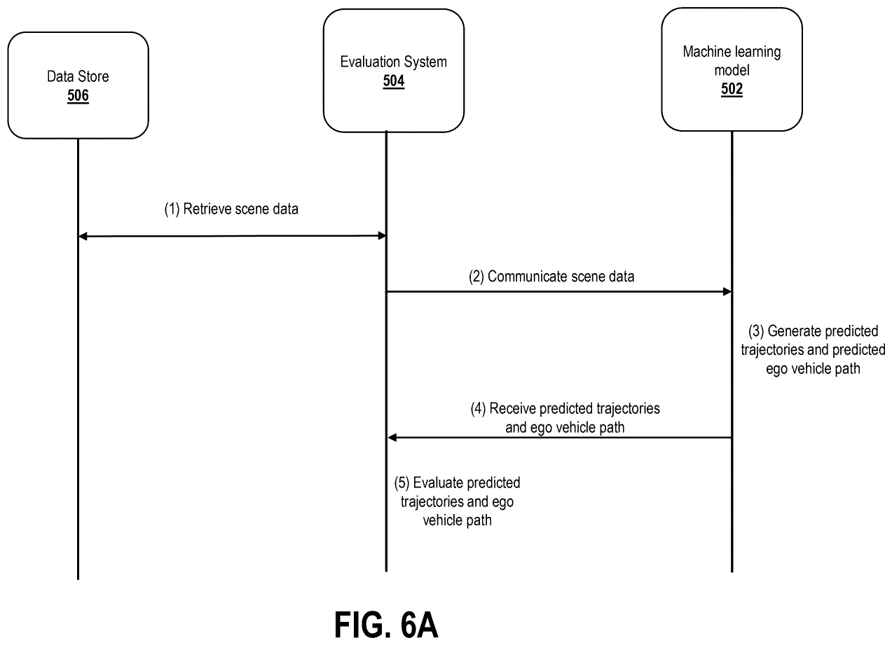

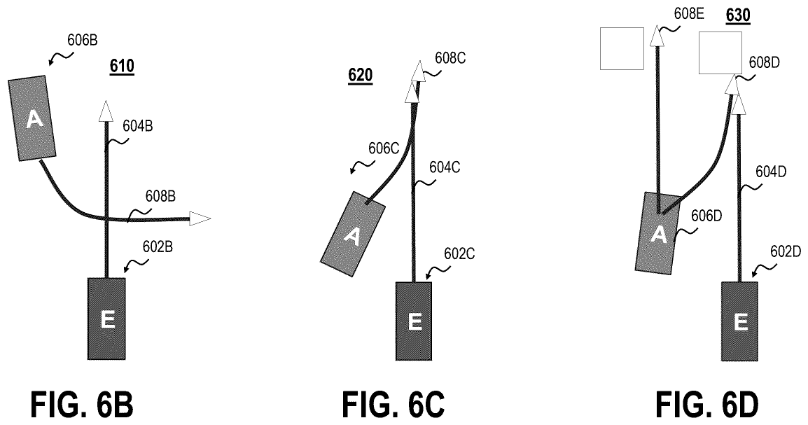

FIG. 6A is a data flow diagram illustrating example communications between various components of the evaluation environment 500 to evaluate the ability of the machine learning model 502 to accurately predict an obstacle.

At (1) the evaluation system 504 retrieves test data and/or ground truth data corresponding to a particular scene from the data store 506. As described herein, the test data or ground truth data may include image data associated with a scene, semantic data associated with features extracted from the image data and that corresponds to agents detected in the scene, velocity data associated with the velocity of the detected agents in the scene, and/or orientation/location data associated with the orientation/location of the one or more agents in the scene over time and the orientation/location of the ego vehicle in the scene over time. As described herein, as the data for the ego vehicle and agents in a scene is collected and/or generated many times per second, the ground truth data for a particular scene may include thousands, millions, or billions of points of data and may correspond to megabytes, gigabytes or more, rendering it impossible for a human to process or review.

At (2), the evaluation system 504 communicates a subset of the ground truth data corresponding to the particular driving scene (also referred to herein as scene test data) to the machine learning model 502. In some cases, the evaluation system 504 communicates scene test data that corresponds to a particular point in time. For example, the ground truth data may include data that corresponds to five or ten seconds of driving of the ego vehicle, but the evaluation system 504 may communicate (only) a subset thereof (e.g., at time t=0 or some other point int time) to the machine learning model 502 as the scene test data. In this way, the evaluation system 504 may simulate driving for the machine learning model 502 and allow the machine learning model 502 to generate predicted trajectories for the agents in a scene and a predicted ego vehicle path through the scene based on the received scene test data and without knowing how the agents or ego vehicle actually interact.

At (3), the machine learning model 502 generates predicted trajectories for the agents and a predicted ego path for the ego vehicle. In some cases, such as when the machine learning model 502 is a regression-based model, the predictions generated by the machine-learning model may be referred as regression-based predictions. The predicted ego path may indicate a predicted path of the ego vehicle through the scene. In some cases, the predicted ego path corresponds to a path of the ego vehicle if no adjustments are made to the current path. For example, the predicted ego path may correspond to the path of the ego vehicle through the scene if the ego vehicle maintains its velocity and heading.

The predicted trajectories may indicate a path that the machine learning model 502 predicts that agent(s) in the scene will take through the scene. For example, the predicted trajectories may reflect the machine learning model's 502 prediction of how the agents will behave within the driving scene, such as whether the agent is likely to drive straight, turn or veer left/right, accelerate/decelerate, etc. As described herein, the trajectories may include a series of spatiotemporal points indicating an estimated location of the agent over time.

In some cases, machine learning model 502 generates one trajectory for an agent. FIG. 6B is a bird's eye view of an example scene 610 showing an ego vehicle 602B, a predicted ego vehicle path 604B generated by the machine learning model 502, an agent 606B, and a predicted trajectory 608B of the agent 606B generated by the machine learning model 502. In the illustrated example, the predicted trajectory 608B of the agent 606B intersects with the predicted ego vehicle path 604B (also referred to herein as an ego-intersecting trajectory).

FIG. 6C is another bird's eye view of an example scene 620 showing an ego vehicle 602C, a predicted ego vehicle path 604C generated by the machine learning model 502, an agent 606C, and a predicted trajectory 608C of the agent 606C generated by the machine learning model 502. In the illustrated example, the predicted trajectory 608C of the agent 606C is an ego-intersecting trajectory.

In certain cases, the machine learning model 502 generates multiple trajectories for the agent. In some such cases, the machine learning model 502 may associate (or assign) a probability with (or to) some of all of the trajectories indicating the machine learning model's 502 estimate of the likelihood that the corresponding trajectory will occur.

FIG. 6D is a bird's eye view of an example scene 630 showing an ego vehicle 602D, a predicted ego vehicle path 604D generated by the machine learning model 502, an agent 606D, and two predicted trajectories 608D, 608E of the agent 606D generated by the machine learning model 502. In the illustrated example, the predicted trajectory 608D is an ego-intersection trajectory and the predicted trajectory 608E is not an ego-intersection trajectory.

Although FIGS. 6B-6D show only one agent, it will be understood that a particular scene may include multiple agents and that the machine learning model 502 may generate predicted trajectories for some or all of the agents in a scene. In addition, although FIG. 6D shows only two predicted trajectories 608D, 608E for the agent 606D, it will be understood that the machine learning model 502 may generate more than two predicted trajectories, such as ten or more, or one hundred or more trajectories, for some or all of the agents in a scene. Moreover, each predicted trajectory may include tens, hundreds, or thousands of time and location points corresponding to a predicted location of the agent 606D at a given time. As such, the machine learning model 502 may generate thousands, millions, or more data points in real time corresponding to various agents in a scene at any given time and communicate the data points to the evaluation system 504 for analysis in real-time.

In some cases, the machine learning model 502 may also generate an indication of a potential obstacle for the agent in the scene. For example, the machine learning model 502 may determine whether the predicted trajectory of an agent intersects the predicted path of the ego vehicle. In some cases, if the predicted trajectory intersects with the predicted path of the ego vehicle (e.g., is an ego-intersecting trajectory), the machine learning model 502 may identify the agent as a potential obstacle. In certain cases, the machine learning model 502 may identify the agent as a potential obstacle if the predicted trajectory of the agent is an ego-intersecting trajectory and if the predicted trajectory of the agent satisfies an intersection timing threshold. In some cases, the machine learning model may determine that the predicated trajectory satisfies the intersection timing threshold based on a determination that the agent is predicted (according to the predicted trajectory) to arrive at the intersection of the predicted trajectory of the agent and the predicted path of the ego vehicle (also referred to herein as the agent-ego intersection point) before (or at the same time as) the ego vehicle, or is otherwise predicted to be at the agent-ego intersection point at the same time as the ego vehicle.

In some such cases, the machine learning model 502 may assess some or all of the agents in the scene to determine whether they are potential obstacles. In certain cases, the machine learning model 502 does not make an obstacle prediction. For example, the machine learning model 502 may send the predicted trajectories and/or predicted path to the evaluation system 504 and the evaluation system 504 may determine whether the agent is a potential obstacle for the machine learning model 502. For example, the evaluation system 504 may identify the agent as a potential obstacle (e.g., on behalf of the machine learning model 502) if the predicted trajectory of the agent is an ego-intersecting trajectory and if the predicted trajectory satisfies an intersection timing threshold.

Returning to FIG. 6A, at (4), the evaluation system 504 receives the generated and predicted agent trajectories and ego path from the machine learning model 502 (and the potential obstacle prediction as the case may be). As described herein, the evaluation system 504 may receive thousands, millions, or more data points in real time from the machine learning model 502 and the data points may correspond to various agents in a scene at any given time.

At (5), the evaluation system 504 evaluates the generated and predicted agent trajectories and ego path from the machine learning model 502 to determine the accuracy of the machine learning model's ability to predict obstacles. In some cases, the evaluation system 504 evaluates thousands, millions, or more data points in real time, such as, but not limited to, in less than one second.

In some cases, the machine learning model 502 may convert the regression-based predictions to classification-based predictions and/or provide the evaluation system 504 with an obstacle prediction or potential obstacle prediction for one or more agents in the scene. In certain cases, such as when no obstacle prediction is generated by the machine learning model 502 or received by the evaluation system 504, the evaluation system 504 may convert the regression-based predictions to classification-based predictions. For example, the evaluation system 504 may use the agent trajectory generated by the machine learning model 502 and the generated ego path to predict whether a particular agent is or will be an obstacle (also referred to herein as a predicted obstacle). For example, if the agent trajectory generated by the machine learning model 502 intersects with the path of the ego path (also referred to herein as an ego-intersecting trajectory), the evaluation system 504 may determine that the machine learning model 502 will or is likely to consider the agent to be a potential obstacle. If the agent trajectory does not intersect the ego path, the evaluation system 504 may determine that the machine learning model 502 does not or is unlikely to consider the agent to be a potential obstacle. In certain cases, the evaluation system 504 may identify the agent as a potential obstacle if the predicted trajectory of the agent is an ego-intersecting trajectory and if the predicted trajectory of the agent satisfies an intersection timing threshold (non-limiting example: indicates that the agent is predicted to arrive at the agent-ego intersection point before (or at the same time as) the ego vehicle, or is otherwise predicted to be at the agent-ego intersection point at the same time as the ego vehicle).

In some such cases, to determine whether the machine learning model 502 is likely to treat an agent as an obstacle (or predicted obstacle), the evaluation system 504 can determine whether a trajectory for the agent that intersects the ego vehicle path satisfies an obstacle probability threshold.

As described herein, in some cases, the machine learning model 502 may provide multiple potential trajectories for an agent and may include or associate a probability with some or all of the potential trajectories. Some of the potential trajectories may be ego-intersecting trajectories and others may not. The respective probability of the potential trajectories may reflect the machine learning model's 502 estimate of the likelihood that the particular predicted trajectory will occur.

In cases where the evaluation system 504 receives multiple trajectories from the machine learning model 502 for a particular agent and respective probabilities, the evaluation system 504 may identify the trajectory/ies for the agent that are ego-intersecting trajectories. For example, with reference to FIG. 6D, the evaluation system 504 (or machine learning model 502) may identify from the set of predicted trajectories 608D, 608E, a subset thereof (e.g., predicted trajectory 608D) that are ego-intersecting trajectories.

The evaluation system 504 may use the respective probabilities of the ego-intersecting trajectories to determine whether the machine learning model 502 predicts or is likely to predict the agent to be an obstacle. For example, the evaluation system 504 may compare the respective probability of the ego-intersecting trajectories with an obstacle probability threshold. If the probability of at least one ego-intersecting trajectory satisfies the obstacle probability threshold, the evaluation system 504 can determine that the machine learning model 502 predicts the agent to be an obstacle or is likely to treat the agent as a predicted obstacle.

In some cases, the evaluation system 504 may use the sum of probabilities of one or more ego-intersecting trajectories to determine whether the machine learning model 502 predicts the agent to be an obstacle (e.g., treats the agent as a predicted obstacle). For example, in some cases, no one ego-intersecting trajectory may have a probability that satisfies the obstacle probability threshold, whereas in combination multiple ego-intersecting trajectories may indicate a relatively high probability that the agent is an obstacle. Accordingly, in some cases, the machine learning model 502 may compare the sum of probabilities of one or more ego-intersecting trajectories with the obstacle probability threshold. If the sum of the probabilities satisfies the obstacle probability threshold (e.g., is greater than), the evaluation system 504 may determine that the machine learning model 502 predicts the agent to be an obstacle. Conversely, if the sum of the probabilities does not satisfy the obstacle probability threshold, the evaluation system 504 may determine that the machine learning model 502 does not predict the agent to be an obstacle or predicts the agent to be a non-obstacle.

If none of the probabilities (or sum of probabilities) of the ego-intersecting trajectories satisfy the obstacle probability threshold, the evaluation system 504 may determine that the machine learning model 502 does not predict the agent to be an obstacle or predicts the agent to be a non-obstacle.

Before, after, or concurrent to determining whether the machine learning model 502 predicts an agent to be an obstacle, the evaluation system 504 may use the ground truth data to determine whether the agent was/is an (actual) obstacle to the ego vehicle. For example, the evaluation system 504 may review the ground truth data to determine whether the agent reached an intersection point with the ego's path before the ego. If the evaluation system 504 determines that the agent reached the intersection point before the ego, the evaluation system 504 may determine that the agent was an (actual) obstacle to the ego vehicle. If the evaluation system 504 determines that the agent did not reach the intersection point before the ego, the evaluation system 504 may determine that the agent was not an obstacle to the vehicle. For example, the system may determine that the agent's path was different from the predicted trajectory, that the agent arrived at the intersection point after the vehicle, etc.

The evaluation system 504 may use the (actual) obstacle determination based on ground truth data (also referred to herein as ground truth-based obstacle determination) to determine the accuracy of the machine learning model's 502 obstacle prediction. In some cases, if the ground truth-based obstacle determination matches the machine learning model 502 obstacle prediction, the evaluation system 504 can determine that the machine learning model 502 accurately predicted that a particular agent is an obstacle. For example, if the machine learning model 502 predicts that an agent will be an obstacle and the ground truth-based obstacle determination indicates that the agent was an obstacle, the evaluation system 504 may determine that the machine learning model's 502 prediction was accurate. Similarly, if the if the machine learning model 502 predicts that an agent will not be an obstacle and the ground truth-based obstacle determination indicates that the agent was not an obstacle, the evaluation system 504 may determine that the machine learning model's 502 prediction was accurate.

If the ground truth-based obstacle determination does not match the machine learning model's 502 obstacle prediction, the evaluation system 504 may determine that the machine learning model 502 did not accurately predict that a particular agent is an obstacle. For example, if the machine learning model 502 predicts that an agent will be an obstacle and the ground truth-based obstacle determination indicates that the agent was not an obstacle, the evaluation system 504 may determine that the machine learning model's 502 prediction was not accurate (or inaccurate) (e.g., a false positive). Similarly, if the machine learning model 502 predicts that an agent will not be an obstacle and the ground truth-based obstacle determination indicates that the agent was an obstacle, the evaluation system 504 may determine that the machine learning model's 502 prediction was not accurate (e.g., a false negative).

It will be understood that agents within a scene change frequently if not constantly. For example, the velocity, heading, position, acceleration of agents within a vehicle scene change due to their own movement and/or due to the movement of the ego vehicle. In addition, during vehicle navigation, to understand a scene, an autonomous vehicle identifies agents and predicts trajectories for some or all of the identified agents in the scene hundreds, thousands, or more times per second.

Thus, to safely navigate a scene, an autonomous vehicle generates hundreds, thousands or millions of trajectories in less than a second using thousands, millions, or more data points. The amount of data and computational resources used to generate a trajectory, and short time frame in which to generate them makes this impossible for a person or even many persons to perform.

Similarly, to test the accuracy of the machine learning model's 502 obstacle prediction, the evaluation system 504 may perform the evaluation procedure millions or billions of times for millions or more different environments and scenes in order to evaluate the machine learning model 502 in a wide variety of circumstances and driving scenes.

The ground truth data used to evaluate the machine learning model 502 may correspond to minutes, hours, or days of driving data. Each point of time of the ground truth data may include hundreds, thousands, millions, or billions or data points, and there may be hundreds, thousands, or millions of points of time within one second of ground truth data. Thus, the amount of data used to evaluate the machine learning model's 502 obstacle prediction and the limited amount of time to obtain results make it impossible for a human to perform alone or with others.

In some cases, the evaluation system 504 may use hundreds or thousands of processors concurrently and/or as a distributed computing system to test the machine learning model's 502 agent prediction in a reasonable amount of time.

Moreover, the evaluation system may use some or many different obstacle probability thresholds to evaluate the machine learning model 502 and compare the effectiveness of the model to other machine learning models. For example, the evaluation system 504 may evaluate the predicted trajectories and ego path from the machine learning model 502 using various obstacle probability thresholds to calculate precision and recall values for each obstacle probability threshold. The evaluation system 504 may plot the various precision-recall values for each obstacle probability threshold to generate a precision-recall curve. The evaluation system 504 may aggregate data generated by the machine learning model 502 from a plurality of scenes to generate a smoother precision-recall curve. The evaluation system 504 may analyze the precision-recall curve or compare the precision-recall curve generated based on data received from the machine learning model 502 against a curve generated based on data received from a different machine learning model to identify the more accurate machine learning model.

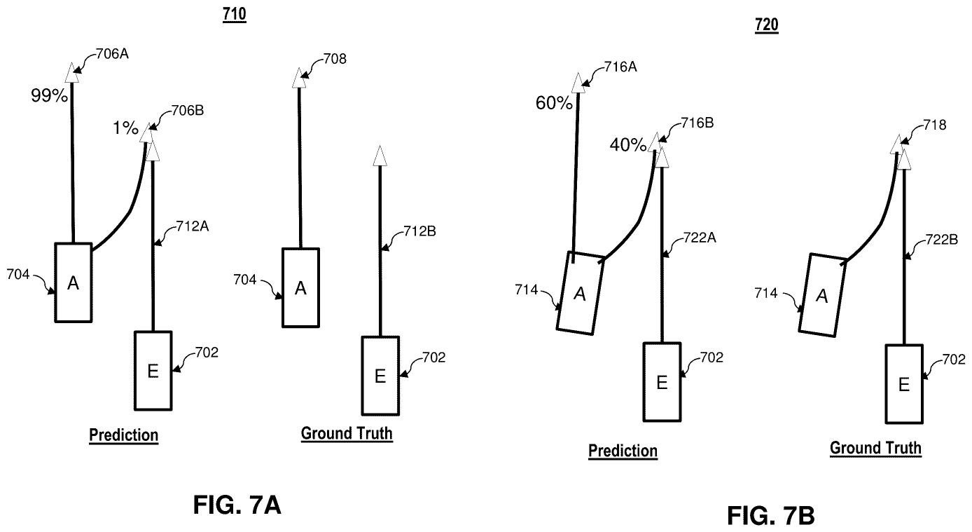

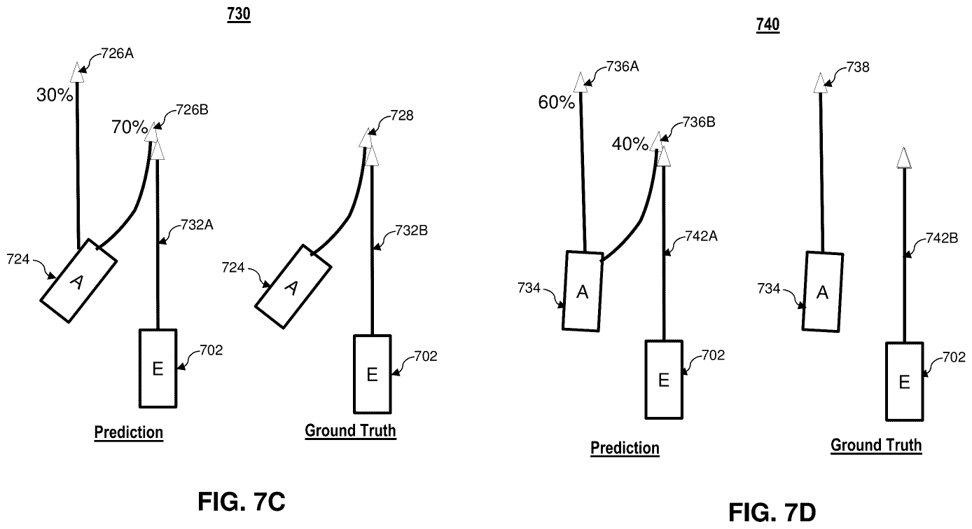

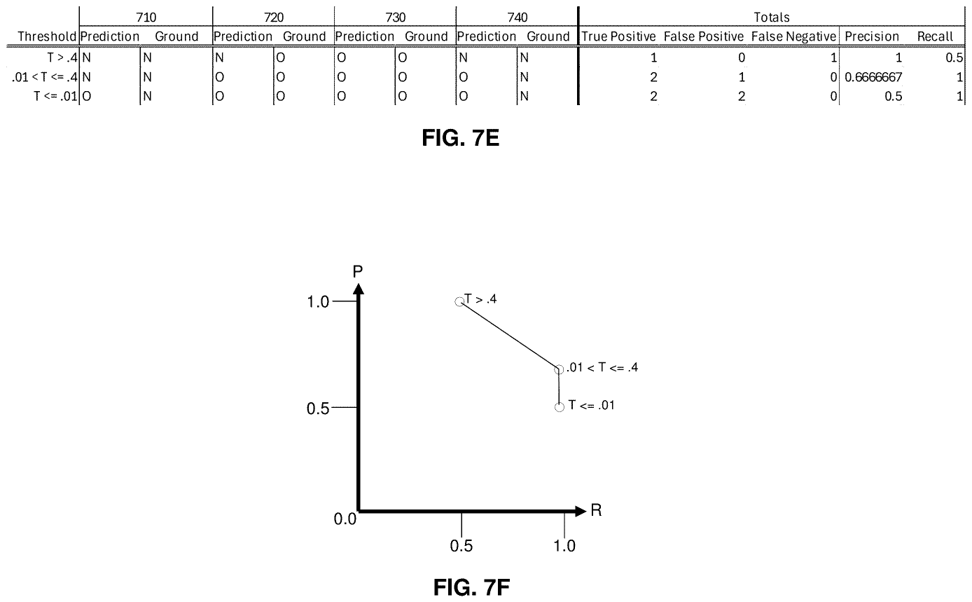

FIG. 7A is a bird's eye view of an example scene 710 showing an ego vehicle 702, a predicted ego vehicle path 712A generated by the machine learning model 502, an agent 704, two predicted agent trajectories 706A, 706B of the agent 704 generated by the machine learning model 502, a ground truth agent path 708 of the agent 704, and a ground truth ego path 712B of the ego vehicle 702. In the illustrated example of FIG. 7A, the predicted trajectory 706A is not an ego-intersection trajectory and the predicted trajectory 706B is an ego-intersection trajectory. Moreover, the machine learning model 502 estimates that the predicted trajectory 706A has a 99% probability of occurring and the predicted trajectory 706B has a 1% probability of occurring.

As described herein, to determine whether the machine learning model 502 predicts an agent to be an obstacle, the evaluation system 504 can determine whether a trajectory for the agent is an ego-intersection trajectory that satisfies an intersection timing threshold and an obstacle probability threshold. In the illustrated scenario 710, since the machine learning model 502 predicts that there is a 1% chance that the agent 704 will follow the predicted trajectory 706B, which is an ego-intersection trajectory, the agent 704 will be considered a predicted obstacle if the obstacle probability threshold is 1% or less. If the obstacle probability threshold is greater than 1%, then the evaluation system 504 can disregard the predicted trajectory 706B, leaving only the predicted trajectory 706A, which is not an ego-intersection trajectory. Accordingly, if the obstacle probability threshold is greater than 1%, the agent 704 will not be considered a predicted obstacle.

In the illustrated scenario 710, the ground truth data indicates that the agent 704 follows the ground truth agent path 708, which is not an ego-intersection trajectory. As such, an obstacle probability threshold of 1% or less results in a false positive obstacle identification as the machine learning model 502 will incorrectly predict the agent 704 is an obstacle, when the ground truth data shows the opposite. However, an obstacle probability threshold greater than 1% will result in a true negative obstacle identification as the model will correctly predict the agent 704 is not an obstacle.

FIG. 7B is a bird's eye view of an example scene 720 showing the ego vehicle 702, a predicted ego vehicle path 722A generated by the machine learning model 502, an agent 714, two predicted agent trajectories 716A, 716B of the agent 714 generated by the machine learning model 502, a ground truth agent path 718 of the agent 714, and a ground truth ego path 722B of the ego vehicle 702. In the illustrated scene 720, the agent 714 is angled toward the ego vehicle 702. Additionally, the predicted trajectory 716A is not an ego-intersection trajectory and the predicted trajectory 716B is an ego-intersection trajectory. Moreover, the machine learning model 502 estimates that the predicted trajectory 716A has a 60% probability of occurring and the predicted trajectory 716B has a 40% probability of occurring.

In the illustrated scenario 720, since the machine learning model 502 predicts that there is a 40% chance that the agent 714 will follow the predicted trajectory 716B, which is an ego-intersection trajectory, the agent 714 will be considered a probable or predicted obstacle if the obstacle probability threshold is 40% or less. If the obstacle probability threshold is greater than 40%, then the evaluation system 504 can disregard the predicted trajectory 716B (and not identify the agent 714 as a probable obstacle), leaving only the predicted trajectory 716A, which is not an ego-intersection trajectory. Accordingly, if the obstacle probability threshold is greater than 40%, the agent 704 will not be considered a probable obstacle.

The ground truth data for the illustrated scenario 720 shows that the agent 714 follows the ground truth agent path 718, which is an ego-intersection trajectory. As such, an obstacle probability threshold of 40% or less will result in a true positive obstacle identification as the machine learning model 502 will correctly identify the agent 714 as an obstacle. However, an obstacle probability threshold greater than 40% will result in a false negative obstacle identification as the machine learning model 502 will incorrectly identify the agent 714 as not an obstacle or a non-obstacle.

FIG. 7C is a bird's eye view of an example scene 730 showing the ego vehicle 702, a predicted ego vehicle path 732A generated by the machine learning model 502, an agent 724, two predicted agent trajectories 726A, 726B of the agent 724 generated by the machine learning model 502, a ground truth agent path 728 of the agent 724, and a ground truth ego path 732B of the ego vehicle 702. In the illustrated example, the agent 724 is angled toward the ego vehicle 702. Additionally, the predicted trajectory 726A is not an ego-intersection trajectory and the predicted trajectory 726B is an ego-intersection trajectory. Moreover, the machine learning model 502 estimates that the predicted trajectory 726A has a 30% probability of occurring and the predicted trajectory 726B has a 70% probability of occurring.

In the illustrated scenario 730, since the machine learning model 502 predicts that there is a 70% chance that the agent 724 will follow the predicted trajectory 726B, which is an ego-intersection trajectory, the agent 724 will be considered an obstacle if the obstacle probability threshold is 70% or less. If the obstacle probability threshold is greater than 70%, then the evaluation system 504 can disregard the predicted trajectory 726B, leaving no ego-intersection trajectories. Accordingly, if the obstacle probability threshold is greater than 70%, the agent 724 will not be considered an obstacle.

The ground truth data for the illustrated scenario 730 shows that the agent 724 follows the ground truth agent path 728, which is an ego-intersection trajectory. So, an obstacle probability threshold of 70% or less will result in a true positive obstacle identification as the machine learning model 502 will correctly identify the agent 724 as an obstacle. However, an obstacle probability threshold greater than 70% will result in a false negative obstacle identification as the machine learning model 502 will incorrectly identify the agent 724 as not an obstacle.

FIG. 7D is a bird's eye view of an example scene 740 showing the ego vehicle 702, a predicted ego vehicle path 742A generated by the machine learning model 502, an agent 734, two predicted agent trajectories 736A, 736B of the agent 734 generated by the machine learning model 502, a ground truth agent path 738 of the agent 734, and a ground truth ego path 742B of the ego vehicle 702. In the illustrated example, the agent 734 is angled toward the ego vehicle 702. Additionally, the predicted trajectory 736A is not an ego-intersection trajectory and the predicted trajectory 736B is an ego-intersection trajectory. Moreover, the machine learning model 502 estimates that the predicted trajectory 736A has an 80% probability of occurring and the predicted trajectory 736B has a 20% probability of occurring.

In the illustrated scenario 740, since the machine learning model 502 predicts that there is a 40% chance that the agent 734 will follow the predicted trajectory 736B, which is an ego-intersection trajectory, the agent 734 will be considered an obstacle if the obstacle probability threshold is 40% or less. If the obstacle probability threshold is greater than 40%, then the evaluation system 504 can disregard the predicted trajectory 736B, leaving no ego-intersection trajectories. Accordingly, if the obstacle probability threshold is greater than 40%, the agent 734 will not be considered an obstacle.

The ground truth data for the illustrated scenario 740 shows that the agent 734 follows the ground truth agent path 738, which is not an ego-intersection trajectory. So, an obstacle probability threshold of 40% or less will result in a false positive obstacle identification as the machine learning model 502 will incorrectly identify the agent 734 as an obstacle. However, an obstacle probability threshold greater than 40% will result in a true negative obstacle identification as the machine learning model 502 will correctly identify the agent 734 as not an obstacle.

Using data from a plurality of scenarios, the evaluation system 504 can generate a precision-recall curve to measure the efficacy of the machine learning model 502. FIG. 7E is a table of the outcomes of the scenarios 710, 720, 730, and 740 at various obstacle probability thresholds, along with the number of true positive predictions, false positive predictions, false negative predictions, as well as precision and recall values for each obstacle probability threshold. An “N” indicates that the agent is not an obstacle, and an “O” indicates that the agent is an obstacle. A true positive indicates that the model correctly identified the agent as an obstacle, a false positive indicates that the model incorrectly identified the agent as an obstacle, and a false negative indicates that the mode incorrectly identified the agent as not an obstacle. In the illustrated example, the precision and recall scores for a particular obstacle probability threshold are calculated using the following formulas:
Precision: True Positive/(True Positive+False Positive)
Recall: True Positive/(True Positive+False Negative)

FIG. 7F illustrates a graph of the precision-recall values calculated in the table of FIG. 7E. In the illustrated example, the precision values are along the y-axis and recall values are along the x-axis. Each point on the graph represents a different obstacle probability threshold value. Although only three obstacle probability threshold values are demonstrated in the illustrated example, more obstacle probability threshold values can be added to generate a smoother curve. In some embodiments, the scenarios 710, 720, 730, and 740 can be run through another machine learning model in addition to the machine learning model 502. Precision and recall values for the obstacle probability threshold s illustrated in FIGS. 7E and 7F can be calculated based on the predictions made by the additional machine learning model and graphed. The area under the curves generated based on the data from the machine learning model 502 and the additional machine learning model can be calculated and compared to determine whether one model is more effective than the other. To develop a model with both high precision and high recall, a larger area under the curve can be desired. In some cases, the model with the larger area under the curve may be considered the more effective model.

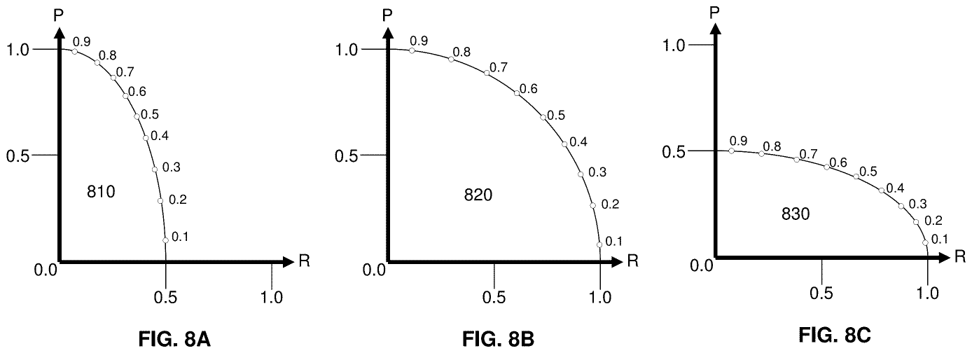

FIGS. 8A, 8B, and 8C illustrate precision-recall curves generated based on data from three separate machine learning models using the same training set and same obstacle probability threshold values. As shown, the model of FIG. 8A has better precision than recall, the model of FIG. 8B has similar levels of precision and recall, and the model of FIG. 8B has better recall than precision. Comparing the areas under the curves 810, 820, and 830, the model of FIG. 8B has the highest efficacy of the three.

In some cases, the evaluation system 504 may generate the curves 810, 820, 830, compare them, and identify the machine learning model that corresponds to curve 820 as the most effective. Moreover, the evaluation system 504 may identify ways in which the corresponding models may be improved. For example, the evaluation system 504 may indicate that the model of FIG. 8A may be adjusted to improve recall (e.g., reduce false negatives), and the model of FIG. 8C may be adjusted to improve precision (e.g., reduce false positives).

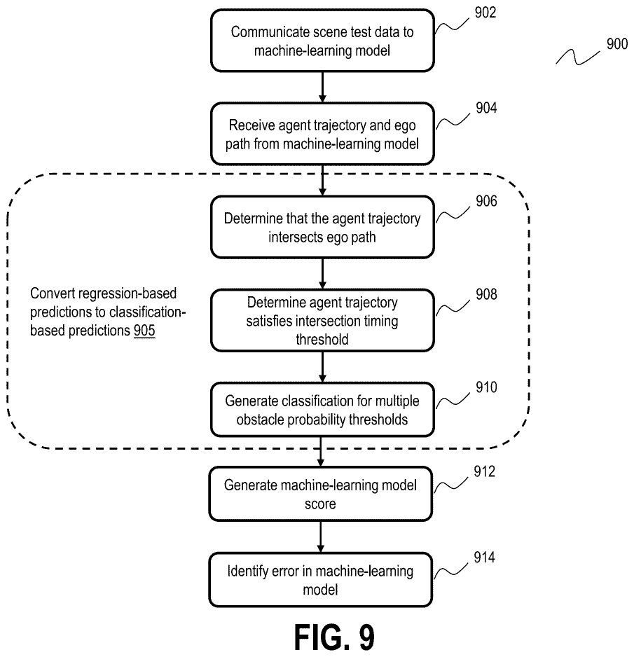

FIG. 9 is a flow diagram illustrating an example of a routine 900 for improving the accuracy of a machine learning model. The flow diagram illustrated in FIG. 9 is provided for illustrative purposes only. It will be understood that one or more of the steps of the routine illustrated in FIG. 9 may be removed or that the ordering of the steps may be changed.

At block 902, the evaluation system 504 communicates scene data (also referred to as scene test data) to a machine learning model. As described herein, the scene data may include data corresponding to agents and an ego vehicle in an environment, such as, but not limited to, position and heading data for the agents and ego vehicle.

At block 904, the evaluation system 504 receives at least one predicted trajectory for at least one agent and at least one predicted trajectory for the ego vehicle (also referred to as predicted ego path). As described herein, the machine learning model 502 may be a regression-based model trained to predict trajectories for objects within a scene, including trajectories for agents and an ego vehicle within a vehicle scene using position, heading, and/or orientation data of the agents and the ego vehicle, respectively. As such, the outputs of the machine learning model 502, such as the agent trajectories and/or ego path may be considered regression-based predictions.

In some cases, the machine learning model 502 may generate one or more trajectories (and corresponding probabilities) for some or all of the agents in a scene. In certain cases, the machine learning model 502 may assign a probability to a trajectory generated for a particular agent. The probability may correspond to an estimated likelihood that the agent will travel along the predicted trajectory. In certain cases, the machine learning model 502 may generate multiple trajectories for some or all of the agents and/or assign probabilities to the trajectories indicating the estimated likelihood that the agent will travel along a respective trajectory. Similarly, the machine learning model 502 may generate one or more trajectories or paths for the ego vehicle and assign probabilities to the predicted trajectories or path(s).

The trajectories (for the agent(s) and/or ego vehicle) may include multiple spatiotemporal points indicating an estimated location of the agent and/or ego vehicle at a particular time. In certain cases, the trajectories may include hundreds, thousands, or more spatiotemporal points.

At block 906, the evaluation system 504 determines that an agent trajectory intersects the ego path (e.g., is an ego-intercepting trajectory). As described herein, the evaluation system 504 can compare the spatiotemporal points of the agent trajectory with the spatiotemporal points of the ego path to identify an intersection. In some cases, the evaluation system 504 can analyze some or all of the trajectories of an agent or the agents in a scene to identify the agent trajectories that are ego-intercepting trajectories.

At block 908, the evaluation system 504 determines that the agent trajectory satisfies an intersection timing threshold. As described herein, the evaluation system 504 can determine that the agent trajectory satisfies the intersection timing threshold based on a determination that (according to the agent trajectory) the agent is estimated to arrive at an agent-ego intersection point before (or at the same time as) the ego vehicle or is otherwise predicted to be at the agent-ego intersection point at the same time as the ego vehicle. In some cases, the evaluation system 504 can analyze some or all of the trajectories of an agent or the agents in a scene to identify the agent trajectories that satisfy the intersection timing threshold.

In certain cases, the evaluation system 504 can identify an agent trajectory that is an ego-intercepting trajectory and that satisfies the intersection timing threshold as a possible obstacle or potential obstacle.

At block 910, the evaluation system 504, for multiple obstacle probability thresholds, generates a classification for the first agent as an obstacle (also referred to herein as predicted obstacle) or a non-obstacle (also referred to as predicted non-obstacle). In some cases, the evaluation system 504 performs block 910 (only) for agent trajectories that are ego-intercepting trajectories and that satisfy the intersection timing threshold (e.g., are identified as potential obstacles).

As described herein, the evaluation system 504 may classify the agents as predicated obstacles or predicted non-obstacles by comparing the probability assigned to an agent trajectory with an obstacle probability threshold. If the agent trajectory satisfies the obstacle probability threshold (e.g., is greater than or equal to the obstacle probability threshold), the evaluation system 504 may classify the agent as a predicted obstacle. If the agent trajectory does not satisfy the obstacle probability threshold (e.g., is less than the obstacle probability threshold), the evaluation system 504 may review the assigned probabilities of any other trajectories of the agent. If none of the predicted trajectories of the agent satisfy the obstacle probability threshold, the evaluation system 504 may classify the agent as a predicted non-obstacle. As such, in certain cases, if any agent trajectory of an agent (that is identified as a potential obstacle) satisfies the obstacle probability threshold, the evaluation system 504 may classify the agent as a predicted obstacle.

As described herein, the evaluation system 504 may review the agent trajectories of a particular agent individually or collectively. For example, the evaluation system 504 may sum the probabilities of all the trajectories of an agent that are an ego-intercepting trajectory and that satisfy the intersection timing threshold, and compare the summed probability with the obstacle probability threshold. If the sum satisfies the obstacle probability threshold (e.g., is greater than or equal to the obstacle probability threshold), the evaluation system 504 may classify the agent as a predicted obstacle. If the sum does not satisfy the obstacle probability threshold (e.g., is less than the obstacle probability threshold), the evaluation system 504 may classify the agent as a predicted non-obstacle. As another example, the evaluation system 504 may compare the probability of each individual agent trajectory to determine whether to classify the agent as a predicted obstacle or predicted non-obstacle.

As described herein, the evaluation system 504 may use multiple different obstacle probability thresholds and classify each agent based on some or all of the obstacle probability thresholds. For example, using one obstacle probability threshold, a particular agent may be classified as a predicted obstacle. Using a different obstacle probability threshold, the same agent may be classified as a predicted non-obstacle. Accordingly, the same agent may be classified differently depending on the different obstacle probability thresholds. Moreover, as described herein, the evaluation system 504 may use the obstacle probability thresholds to generate multiple classifications for some or all of the agents within the scene. As such, the evaluation system 504 may generate hundreds, thousands, or more classifications in real-time for any particular scene at a particular time.

In addition, as described herein, the scene may change multiple times a second. As such, the evaluation system 504 may generate hundreds, thousands, millions, or more classifications over time (e.g., for some or all changes in the scene and/or at regular intervals such as multiple times a second, etc.) based on the outputs received by the evaluation system 504 from the machine learning model 502.

At block 912, the evaluation system 504 generates a machine-learning model score for the machine learning model 502. As described herein, the evaluation system 504 generates multiple classifications for an agent using different obstacle probability thresholds. The generated classifications may be compared with ground truth data for the agent. For example, the predicated obstacle and predicted non-obstacle classifications made by the evaluation system 504 can be compared with ground truth data that indicates the actual trajectory or path of an agent. Such a comparison may indicate whether the prediction (at a particular obstacle probability threshold) was a true positive, true negative, false positive, or false negative. Using the output of the comparisons, the evaluation system 504 can determine the accuracy of the machine learning model at predicting whether an agent becomes an obstacle. As described herein, in some cases, the evaluation system 504 may generate a precision-recall curve based on the comparisons. In certain cases, the system may generate the machine-learning model score based on the area under the precision-recall curve.

Fewer, more, different, or different blocks may be used with the blocks described herein with reference to routine 900. For example, the evaluation system 504 may identify an error in, corrections for, or modifications to the machine learning model 502 based on the machine-learning model score and/or the comparisons of the classifications with the ground truth data. For example, the evaluation system 504 may indicate changes to reduce the number of false positives or false negatives. In certain cases, the evaluation system 504 may identify at least a portion of the machine learning model 502 to further train, etc.

As another example, in some cases, the evaluation system 504 may repeat blocks 902-912 for a different model or models or repeat blocks 902-912 after the machine learning model 502 is modified or re-trained. In some such cases, the evaluation system 504 may compare the machine-learning model score for the different model(s) and/or different version(s) of the same model to identify the machine learning model or version that is most effective at identifying or predicting obstacles.

As another example, as described herein, blocks 906-910 may be repeated for multiple trajectories of the same agent and for some or all trajectories of some or all agents within a scene to generate a machine-learning model score. Accordingly, as part generating a machine-learning model score, the evaluation system 504 may perform blocks 906-910, hundreds, thousands, or millions of times per second. In certain cases, the routine 900 may stop for a particular trajectory (or skip to another trajectory) based on a determination that the particular trajectory is not an ego-intersecting trajectory (block 906) and/or does not satisfy the intersection timing threshold (block 908).

As described herein, it may be difficult to test, process and/or determine the efficacy of a regression-based machine learning model. Accordingly, as shown in block 905, the evaluation system 504 may convert the regression-based predictions (e.g., agent trajectories and ego path) to classification-based predictions (e.g., predicted obstacle, predicted non-obstacle). As illustrated in FIG. 9, the blocks 906-908 may form part of the block or subroutine to convert regression-based predictions to classification-based predictions and to facilitate the analysis and testing of the machine learning model 502.

Although FIG. 9 is described herein with reference to intersections between an agent trajectory and an ego path, it will be understood that routine 900 may be used for other agent-ego interactions. For example, the machine learning model 502 may be used to predict whether an agent will or will not yield to the ego vehicle, whether an agent will or will not change lanes, whether an agent will or will not back up, whether an agent will or will not turn at an intersection, etc.

Any one or any combination of the examples described herein may be combined with other examples. As such, the examples or cases described herein should not be construed as limiting.

In the foregoing description, aspects and embodiments of the present disclosure have been described with reference to numerous specific details that can vary from implementation to implementation. Accordingly, the description and drawings are to be regarded in an illustrative rather than a restrictive sense. The sole and exclusive indicator of the scope of the invention, and what is intended by the applicants to be the scope of the invention, is the literal and equivalent scope of the set of claims that issue from this application, in the specific form in which such claims issue, including any subsequent correction. Any definitions expressly set forth herein for terms contained in such claims shall govern the meaning of such terms as used in the claims. In addition, when we use the term “further comprising,” in the foregoing description or following claims, what follows this phrase can be an additional step or entity, or a sub-step/sub-entity of a previously-recited step or entity.

What is claimed is:

1. A computer-implemented method, comprising:
communicating scene test data to a regression-based, trajectory prediction machine learning model, wherein the scene test data corresponds to a scene for an ego vehicle;
receiving regression-based predictions from the machine learning model, the regression-based predictions comprising a first predicted agent trajectory generated by the machine learning model and a predicted ego path through the scene, wherein the machine learning model generates the first predicted agent trajectory using the scene test data, wherein the first predicted agent trajectory corresponds to a first agent identified in the scene, wherein the predicted ego path corresponds to the ego vehicle;
converting the regression-based predictions to classification-based predictions, wherein converting the regression-based predictions to the classification-based predictions comprises:
determining that the first predicted agent trajectory intersects the predicted ego path,
determining that the first predicted agent trajectory satisfies an intersection timing threshold, and
based on determining that the first predicted agent trajectory intersects the predicted ego path and determining that the first predicted agent trajectory satisfies the intersection timing threshold, generating, for each of a plurality of obstacle probability thresholds, a classification of predicted obstacle or non-predicted obstacle for the first agent;
generating a machine-learning model score for the machine learning model based on the plurality of classifications, wherein generating the machine-learning model score comprises determining whether each of the plurality of classifications of predicted obstacle or non-predicted obstacle matches corresponding ground truth data; and
indicating at least one modification for the machine learning model based on the machine-learning model score.

2. The computer-implemented method of claim 1, wherein the scene test data comprises a position and heading data for a plurality of agents in the scene.

3. The computer-implemented method of claim 1, wherein the first predicted agent trajectory comprises a plurality of spatiotemporal points for the first agent.

4. The computer-implemented method of claim 1, wherein for a particular obstacle probability threshold of the plurality of obstacle probability thresholds, generating the classification for the first agent comprises determining whether a probability assigned to the first predicted agent trajectory satisfies the particular obstacle probability threshold.

5. The computer-implemented method of claim 1, wherein for a particular obstacle probability threshold of the plurality of obstacle probability thresholds, generating the classification for the first agent comprises determining whether a sum of a probability assigned to the first predicted agent trajectory and a probability assigned to at least one second predicted agent trajectory of the first agent satisfies the particular obstacle probability threshold.

6. The computer-implemented method of claim 1, wherein the first agent is classified as a predicted obstacle for a particular obstacle probability threshold of the plurality of obstacle probability thresholds based on a determination that a probability assigned to the first predicted agent trajectory satisfies the particular obstacle probability threshold.

7. The computer-implemented method of claim 1, wherein the first agent is classified as a predicted obstacle for a first obstacle probability threshold of the plurality of obstacle probability thresholds based on a determination that a probability assigned to the first predicted agent trajectory satisfies the first obstacle probability threshold,
wherein the first agent is classified as a predicted non-obstacle for a second obstacle probability threshold of the plurality of obstacle probability thresholds based on a determination that the probability assigned to the first predicted agent trajectory satisfies the second obstacle probability threshold.

8. The computer-implemented method of claim 1, wherein the first agent is classified as a predicted obstacle for a particular obstacle probability threshold of the plurality of obstacle probability thresholds based on a determination that a sum of a probability assigned to the first predicted agent trajectory and a probability assigned to at least one second predicted agent trajectory of the first agent satisfies the particular obstacle probability threshold.

9. The computer-implemented method of claim 1, wherein the first agent is classified as a predicted non-obstacle for a particular obstacle probability threshold based on a determination that no probability assigned to the first predicted agent trajectory or to another predicated agent trajectory of the first agent satisfies the particular obstacle probability threshold.

10. The computer-implemented method of claim 1, wherein determining that the first predicted agent trajectory satisfies an intersection timing threshold comprises determining that the first agent is estimated to arrive at an intersection of the first predicted agent trajectory and the predicted ego path prior to the ego vehicle.

11. The computer-implemented method of claim 1, wherein the regression-based predictions comprise a second predicted agent trajectory generated by the machine learning model, wherein second prediction agent trajectory corresponds to the first agent identified in the scene, and wherein the computer-implemented method further comprises:
determining that the second predicted agent trajectory does not at least one of intersect the predicted ego path or satisfy the intersection timing threshold; and
based on determining that the second predicted agent trajectory does not at least one of intersect the predicted ego path or satisfy an intersection timing threshold, discarding the second predicted agent threshold.

12. The computer-implemented method of claim 1, wherein the regression-based predictions comprise a second predicted agent trajectory generated by the machine learning model, wherein second prediction agent trajectory corresponds to the first agent identified in the scene, and wherein the computer-implemented method further comprises:
determining that the second predicted agent trajectory intersects the predicted ego path
determining that the second predicted agent trajectory satisfies the intersection timing threshold;
wherein the generating, for each of a plurality of obstacle probability thresholds, a classification of predicted obstacle or non-predicted obstacle for the first agent, is further based on determining that the second predicted agent trajectory intersects the predicted ego path and determining that the second predicted agent trajectory satisfies the intersection timing threshold.

13. A system, comprising:
at least one processor, and
at least one non-transitory storage media storing instructions that, when executed by the at least one processor, cause the at least one processor to:
communicate scene test data to a regression-based, trajectory prediction machine learning model, wherein the scene test data corresponds to a scene for an ego vehicle;
receive regression-based predictions from the machine learning model, the regression-based predictions comprising a first predicted agent trajectory generated by the machine learning model and a predicted ego path through the scene, wherein the machine learning model generates the first predicted agent trajectory using the scene test data, wherein the first predicted agent trajectory corresponds to a first agent identified in the scene, wherein the predicted ego path corresponds to the ego vehicle;
convert the regression-based predictions to classification-based predictions, wherein to convert the regression-based predictions to the classification-based predictions, the instructions, when executed by the at least one processor, cause the at least one processor to:
determine that the first predicted agent trajectory intersects the predicted ego path,
determine that the first predicted agent trajectory satisfies an intersection timing threshold, and
based on a determination that the first predicted agent trajectory intersects the predicted ego path and a determination that the first predicted agent trajectory satisfies the intersection timing threshold, generate, for each of a plurality of obstacle probability thresholds, a classification of predicted obstacle or non-predicted obstacle for the first agent;
generate a machine-learning model score for the machine learning model based on the plurality of classifications, wherein to generate the machine-learning model score, the instructions, when executed by the at least one processor, cause the at least one processor to determine whether each of the plurality of classifications of predicted obstacle or non-predicted obstacle matches corresponding ground truth data; and
indicate at least one modification for the machine learning model based on the machine-learning model score.

14. The system of claim 13, wherein the scene test data comprises a position and heading data for a plurality of agents in the scene.

15. The system of claim 13, wherein the first predicted agent trajectory comprises a plurality of spatiotemporal points for the first agent.

16. The system of claim 13, wherein for a particular obstacle probability threshold of the plurality of obstacle probability thresholds, to generate the classification for the first agent, the instructions, when executed by the at least one processor, cause the at least one processor to determine whether a probability assigned to the first predicted agent trajectory satisfies the particular obstacle probability threshold.

17. The system of claim 13, wherein for a particular obstacle probability threshold of the plurality of obstacle probability thresholds, to generate the classification for the first agent, the instructions, when executed by the at least one processor, cause the at least one processor to determine whether a sum of a probability assigned to the first predicted agent trajectory and a probability assigned to at least one second predicted agent trajectory of the first agent satisfies the particular obstacle probability threshold.

18. The system of claim 13, wherein the first agent is classified as a predicted obstacle for a particular obstacle probability threshold of the plurality of obstacle probability thresholds based on a determination that a probability assigned to the first predicted agent trajectory satisfies the particular obstacle probability threshold.

19. The system of claim 13, wherein the first agent is classified as a predicted obstacle for a first obstacle probability threshold of the plurality of obstacle probability thresholds based on a determination that a probability assigned to the first predicted agent trajectory satisfies the first obstacle probability threshold,
wherein the first agent is classified as a predicted non-obstacle for a second obstacle probability threshold of the plurality of obstacle probability thresholds based on a determination that the probability assigned to the first predicted agent trajectory satisfies the second obstacle probability threshold.

20. At least one non-transitory storage media storing instructions that, when executed by at least one processor, cause the at least one processor to:
communicate scene test data to a regression-based, trajectory prediction machine learning model, wherein the scene test data corresponds to a scene for an ego vehicle;
receive regression-based predictions from the machine learning model, the regression-based predictions comprising a first predicted agent trajectory generated by the machine learning model and a predicted ego path through the scene, wherein the machine learning model generates the first predicted agent trajectory using the scene test data, wherein the first predicted agent trajectory corresponds to a first agent identified in the scene, wherein the predicted ego path corresponds to the ego vehicle;
convert the regression-based predictions to classification-based predictions, wherein to convert the regression-based predictions to the classification-based predictions, the instructions, when executed by the at least one processor, cause the at least one processor to:
determine that the first predicted agent trajectory intersects the predicted ego path,
determine that the first predicted agent trajectory satisfies an intersection timing threshold, and
based on a determination that the first predicted agent trajectory intersects the predicted ego path and a determination that the first predicted agent trajectory satisfies the intersection timing threshold, generate, for each of a plurality of obstacle probability thresholds, a classification of predicted obstacle or non-predicted obstacle for the first agent;
generate a machine-learning model score for the machine learning model based on the plurality of classifications, wherein to generate the machine-learning model score, the instructions, when executed by the at least one processor, cause the at least one processor to determine whether each of the plurality of classifications of predicted obstacle or non-predicted obstacle matches corresponding ground truth data; and
indicate at least one modification for the machine learning model based on the machine-learning model score.
